(19) United States
(12) Patent Application Publication
(10) Pub. No.: US 2026/0303215 A1
(43) Pub. Date: Oct. 1, 2026

(54) BI-DIRECTIONAL OPTICAL COMMUNICATION MODULES AND CABLES

(71) Applicant: Mir Ashkan Seyedi, Atlanta, GA (US)

(72) Inventor: Mir Ashkan Seyedi, Atlanta, GA (US)

(21) Appl. No.: 19/704,547

(22) Filed: Jun. 11, 2026

Related U.S. Application Data
(63) Continuation-in-part of application No. 19/404,897, filed on Dec. 1, 2025.
Application No. 19/404,897 is a continuation of application No. 18/088,877, filed on Dec. 27, 2022, now Pat. No. 12,489,528.

(51) Int. Cl. H04B 10/25; H04B 10/40

(52) U.S. Cl. CPC H04B 10/25891; H04B 10/40

(57) ABSTRACT

Bi-directional optical communication modules, cables, computing systems, and interconnect modules are provided. An example module includes a substrate supporting a first optical transmitter configured to generate a first optical signal at a first wavelength, a first optical receiver configured to receive a second optical signal at a second wavelength distinct from the first wavelength, and a band pass filter communicably coupled to the first optical transmitter, the first optical receiver, and an optical port. The band pass filter passes the first optical signal to the optical port and directs the second optical signal from the optical port into the first optical receiver, enabling simultaneous bi-directional transmission over a single optical fiber between modules coupled to host devices.

### CROSS-REFERENCE TO RELATED APPLICATIONS

This application is a continuation-in-part of U.S. application Ser. No. 19/404,897, filed Dec. 1, 2025, which is a continuation of U.S. application Ser. No. 18/088,877, filed Dec. 27, 2022, the content of which applications are hereby incorporated by reference herein in their entirety.

### BACKGROUND

Communication networks, systems, channels, and the like are employed in a variety of applications in order to transmit data from one location to another. These networks may leverage a large number of modules, cables, and/or other communication devices to provide these communications. As the size of communication networks increase, the number of associated cables between optical components leveraged by these devices similarly increases. Applicant has identified a number of deficiencies and problems associated with networking systems and associated communications. Through applied effort, ingenuity, and innovation, many of these identified problems have been solved by developing solutions that are included in examples of the present disclosure, many examples of which are described in detail herein.

### GENERAL DESCRIPTION

Systems, apparatuses, and methods are disclosed herein for bi-directional optical communication. An example bi-directional optical communication cable may include a first substrate and a first band pass filter supported by the first substrate. A first optical transmitter supported by the first substrate is also provided and communicably coupled with the first band pass filter. The first optical transmitter may be configured to generate optical signals having a first wavelength. A first optical receiver supported by the first substrate may also be provided and communicably coupled with the first band pass filter. The first optical receiver may be configured to receive optical signals having a second wavelength. The components of the first substrate may operate as a first bi-directional optical module.

The bi-directional optical communication cable may further include a second bi-directional optical module that includes a second substrate and a third band pass filter supported by the second substrate. A second optical transmitter supported by the second substrate may also be provided that may be communicably coupled with the third band pass filter. The second optical transmitter may be configured to generate optical signals having the second wavelength. A second optical receiver supported by the second substrate may also be provided that may be communicably coupled with the third band pass filter. The second optical receiver may be configured to receive optical signals having the first wavelength. The bi-directional optical communication cable may include an optical communication medium communicably coupling the first band pass filter and the third band pass filter.

In some examples, the first band pass filter may be configured to pass optical signals received from the first optical transmitter having the first wavelength into the optical communication medium for receipt by the second optical receiver. The first band pass filter may further be configured to direct optical signals received from the optical communication medium and generated by the second optical transmitter having the second wavelength into the first optical receiver.

In some examples, the third band pass filter may be configured to pass optical signals received from the second optical transmitter having the second wavelength into the optical communication medium for receipt by the first optical receiver. The third band pass filter may also be configured to direct optical signals received from the optical communication medium and generated by the first optical transmitter having the first wavelength into the second optical receiver.

In some examples, the optical signals having the first wavelength and optical signals having the second wavelength may be transmitted simultaneously by the optical communication medium.

In some examples, the first band pass filter may further include an input port, and the first optical transmitter may be communicably coupled with the input port of the first band pass filter. The first band pass filter may further include a drop port, a through port, and an add port where the first optical receiver is communicably coupled with the add port of the first band pass filter.

In some examples, the third band pass filter may include an input port, and the second optical transmitter may be communicably coupled with the input port of the third band pass filter. The third band pass filter may further include a drop port, a through port, and an add port where the second optical receiver is communicably coupled with the add port of the third band pass filter.

In some examples, the first optical transmitter may further include a second band pass filter configured to selectively generate optical signals having the first wavelength.

In some further examples, the second band pass filter operating as the first optical transmitter may further include a first wavelength modification element configured to selectively modify a material index of the second band pass filter so as to output the optical signals having the first wavelength.

In some examples, the second optical transmitter may further include a fourth band pass filter configured to selectively generate optical signals having the second wavelength.

In some further examples, the fourth band pass filter operating as the second optical transmitter may further include a second wavelength modification element configured to selectively modify a material index of the fourth band pass filter so as to output the optical signals having the second wavelength.

The above summary is provided merely for purposes of summarizing some example examples to provide a basic understanding of some aspects of the present disclosure. Accordingly, it will be appreciated that the above-described examples are merely examples and should not be construed to narrow the scope or spirit of the disclosure in any way. It will be appreciated that the scope of the present disclosure encompasses many potential examples in addition to those here summarized, some of which will be further described below.

### BRIEF DESCRIPTION OF THE DRAWINGS

Having described certain example examples of the present disclosure in general terms above, reference will now be made to the accompanying drawings. The components illustrated in the figures may or may not be present in certain examples described herein. Some examples may include fewer (or more) components than those shown in the figures.

FIG. 1 illustrates an example bi-directional optical communication cable in accordance with one or more examples of the present disclosure;

FIG. 2 illustrates an example first bi-directional optical communication module in accordance with one or more examples of the present disclosure;

FIG. 3 illustrates an example first band pass filter of the example first bi-directional optical communication module of FIG. 2 in accordance with one or more examples of the present disclosure;

FIG. 4 illustrates operation of the first optical transmitter of the example first bi-directional optical communication module of FIG. 2 at a first wavelength in accordance with one or more examples of the present disclosure;

FIG. 5 illustrates operation of the first optical receiver of the example first bi-directional optical communication module of FIG. 2 at a second wavelength in accordance with one or more examples of the present disclosure;

FIG. 6A illustrates an example instance in which the first optical transmitter includes a second band pass filter to facilitate generation of optical signals in accordance with one or more examples of the present disclosure;

FIG. 6B illustrates an example instance of a tunable band pass filter of a first bi-directional optical communication module in accordance with one or more examples of the present disclosure;

FIG. 6C illustrates an example of a control of the tunable band pass filter of a first bi-directional optical communication module in accordance with one or more examples of the present disclosure;

FIG. 6D illustrates an optical communication module in accordance with one or more examples of the present disclosure;

FIG. 7 illustrates an example second bi-directional optical communication module in accordance with one or more examples of the present disclosure;

FIG. 8 illustrates an example third band pass filter of the example second bi-directional optical communication module of FIG. 7 in accordance with one or more examples of the present disclosure;

FIG. 9 illustrates operation of the second optical transmitter of the example second bi-directional optical communication module of FIG. 7 at a second wavelength in accordance with one or more examples of the present disclosure;

FIG. 10 illustrates operation of the second optical receiver of the example second bi-directional optical communication module of FIG. 7 at a first wavelength in accordance with one or more examples of the present disclosure;

FIG. 11A illustrates an example instance in which the second optical transmitter includes a fourth band pass filter to facilitate generation of optical signals in accordance with one or more examples of the present disclosure;

FIG. 11B illustrates an example instance of a tunable band pass filter of a second bidirectional optical communication module in accordance with one or more examples of the present disclosure;

FIG. 11C illustrates an example of a control for the tunable band pass filter of a second bidirectional optical communication module in accordance with one or more examples of the present disclosure;

FIG. 11D illustrates an optical communication module in accordance with one or more examples of the present disclosure;

FIG. 12 illustrates an example method of manufacturing a bi-directional optical communication module in accordance with one or more examples of the present disclosure;

FIG. 13 illustrates an example bi-directional optical communication system in accordance with one or more examples of the present disclosure;

FIG. 14 shows an example of a computing system with a processing unit and optical module in accordance with one or more examples of the present disclosure; and

FIG. 15 shows an example of computing systems communicating over a bi-directional optical communication system in accordance with one or more examples of the present disclosure.

FIG. 16 illustrates a co-packaged networking device, according to some examples.

FIG. 17A is a top view of a 2.5D integrated co-packaged optics with the host ASIC on an organic substrate, according to some examples.

FIG. 17B is a cross-sectional view of the 2.5D integrated co-packaged optics with the host ASIC on the organic substrate, according to some examples.

FIG. 18 illustrates an optical path from an external laser source (ELS) to an input for a co-packaged optics (CPO) system, according to some examples.

FIG. 19 diagrammatically illustrates a computing system, according to some examples.

### DETAILED DESCRIPTION

While a number of example embodiments are shown and described herein, it will be obvious to those skilled in the art that such embodiments are provided by way of example only. Numerous variations, changes, and substitutions may occur to those skilled in the art. It should be understood that various alternatives to the examples described herein may be employed in practicing the disclosure.

Some examples relate to bi-directional optical communications. Various aspects of the disclosures described herein may be applied to any of the particular applications set forth below or for any other type of systems where bi-directional optical communications are desired. The various examples may be applied as a standalone system or method, or as part of a computing system. It should be understood that different aspects of the disclosure can be appreciated individually, collectively, or in combination with each other.

### Overview

As described above, communication networks, systems, channels, and the like are employed in a variety of applications in order to transmit data from one location to another. These networks may leverage a large number of modules, cables, and/or other communication devices to provide these communications. By way of example, datacenters and/or high-performance computing clusters may use various optical communication modules that are connected (e.g., communicably coupled) via optical fibers, cables, etc. The routing of fibers in datacenters or high-performance computing clusters, however, is often a large concern as these fibers consume a large footprint, are heavy, and/or are often routed in the physical infrastructure of the building housing these components. This issue is further complicated by the fact that optical interconnects used in these environments often use the same wavelength(s) across the entire optical network. In other words, a duplex pair using the same wavelength for transmission requires a distinct transmitting fiber and a distinct receiving fiber to establish an optical link resulting in additional cabling requirements that are expensive and physically intrusive in implementations where space is limited.

By enabling a non-blocking, interference-free bi-directional optical link that leverages the same optical fiber, the examples of the present disclosure substantially reduce (e.g., by at least a factor of two) the routing burdens associated with conventional systems. The examples of the present concept provide bi-directional optical communication modules and cables that leverage band pass filter(s) to pass/direct optical signals having particular wavelengths. For example, a band pass filter may include an input port that is communicably coupled with a first optical transmitter generating optical signals at a first wavelength. The band pass filter may include an add port that is communicably coupled with a first optical receiver that receives optical signals at a second wavelength. In operation, the first band pass filter may pass optical signals received from the first optical transmitter having the first wavelength into an optical communication medium and direct optical signals received from the optical communication medium having the second wavelength into the first optical receiver. Complementary band pass filters may be used on the opposing side of the communication link to similarly direct optical signals based upon wavelength.

Examples of the present disclosure now will be described more fully hereinafter with reference to the accompanying drawings in which some but not all examples are shown. Indeed, the present disclosure may be embodied in many different forms and should not be construed as limited to the examples set forth herein; rather, these examples are provided so that this disclosure will satisfy applicable legal requirements. Like numbers refer to like elements throughout. Furthermore, as would be evident to one of ordinary skill in the art in light of the present disclosure, the terms “substantially” and “approximately” indicate that the referenced element or associated description is accurate to within applicable engineering tolerances.

As used herein, “operatively coupled” may mean that the components are electronically coupled and/or are in electrical communication with one another, or optically coupled and/or are in optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

### Example Bi-Directional Optical Communication Modules and Cables

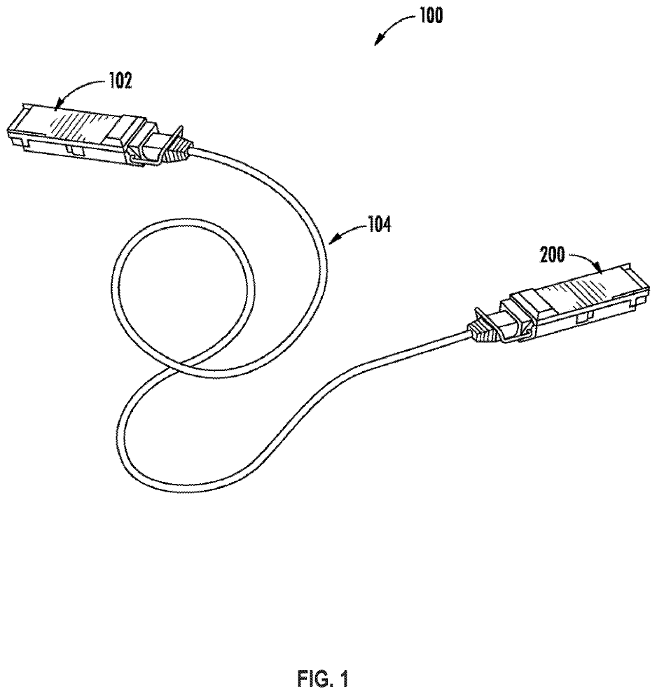

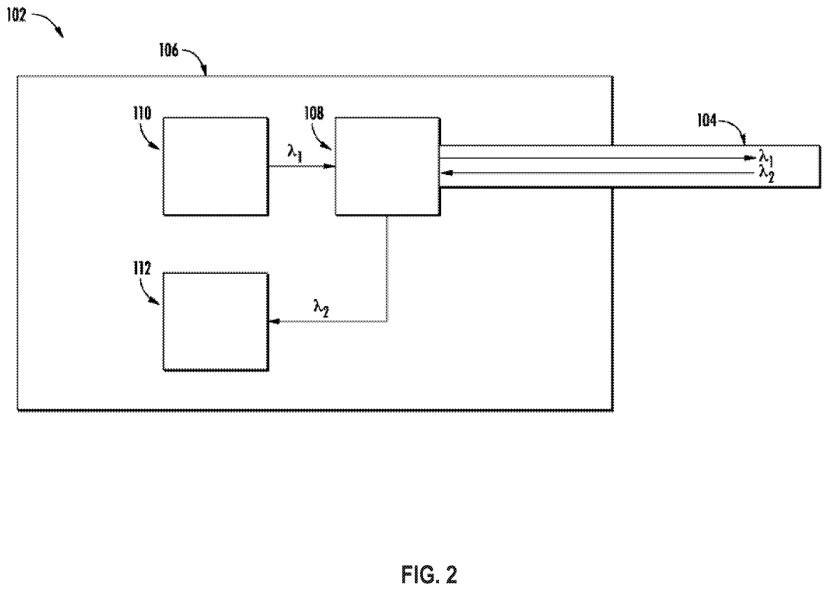

With reference to FIG. 1, an example bi-directional optical communication cable 100 is illustrated in which a first bi-directional optical communication module 102 is communicably coupled with a second bi-directional optical communication module 200 via an optical communication medium 104. As described herein after with reference to FIGS. 2-11, the bi-directional optical communication modules 102, 200 of the present disclosure may include components that generate optical signals (e.g., optical transmitters) having various characteristics (e.g., wavelength or the like) that may be transmitted between the modules 102, 200. As such, the optical communication medium 104 may include any structure configured to support, facilitate, and/or otherwise allow the transmission of optical signals. Said differently, the optical communication medium 104 may be one or more optical fibers, optical cables, and/or the like through which optical signals (e.g., light) may propagate.

The structure of the bi-directional optical communication cable 100 and its components, connections, relationships, and their functions, are provided as examples, and are not meant to limit implementations of the examples described. The present disclosure contemplates that the enclosure, housing, etc. that at least partially support the bi-directional optical communication modules 102, 200 may be dimensioned (e.g., sized and shaped) based upon the intended application of the modules 102, 200 and/or of the bi-directional optical communication cable 100. By way of example, the dimensions of the modules 102, 200 may be determined or otherwise defined by application regulations, multi-source agreements (MSAs), or the like such that the overall footprint or form factor of the modules 102, 200 is subject to these regulations. Furthermore, although described hereinafter with reference to electro-optical components that generate and receive optical signals having a first wavelength (λ1) or a second wavelength (λ₂), the present disclosure contemplates that any number of wavelengths may be used based upon the intended application of the bi-directional optical communication modules 102, 200 and cable 100. Furthermore, the present application contemplates that the number of channels (e.g., the number of optical signals that may be simultaneously transmitted and/or received) by the examples described herein may be scaled (e.g., increased) via the addition of additional band pass filters and associated optical transmitters/receivers.

By way of example and not limitation, the first wavelength (λ₁) and the second wavelength (λ₂) may correspond to wavelengths in an optical communication band, including, by way of example and not limitation, the O-band (approximately 1260 nanometers to 1360 nanometers), the E-band (approximately 1360 nanometers to 1460 nanometers), the S-band (approximately 1460 nanometers to 1530 nanometers), the C-band (approximately 1530 nanometers to 1565 nanometers), the L-band (approximately 1565 nanometers to 1625 nanometers), the U-band (approximately 1625 nanometers to 1675 nanometers), or a short-wavelength band suitable for vertical-cavity surface-emitting laser (VCSEL) operation (approximately 850 nanometers, 905 nanometers, 940 nanometers, or 980 nanometers). In some examples, the first wavelength (λ₁) may comprise a wavelength of at least about 1250 nanometers, 1270 nanometers, 1300 nanometers, 1310 nanometers, 1330 nanometers, 1350 nanometers, or 1400 nanometers. The first wavelength may have a value less than any of values provided or fall within a range between any two of the values provided. The second wavelength (λ₂) may comprise a wavelength of at least at least about 1300 nanometers, 1330 nanometers, 1350 nanometers, 1400 nanometers, 1450 nanometers, 1500 nanometers, 1550 nanometers, or 1600 nanometers. The second wavelength may have a value less than any of values provided or fall within a range between any two of the values provided. The first wavelength (λ₁) and the second wavelength (λ₂) may be non-overlapping. In some examples, the first wavelength (λ₁) may comprise a wavelength of approximately 1310 nanometers and the second wavelength (λ₂) may comprise a wavelength of approximately 1550 nanometers. In some examples, the first wavelength (λ₁) may comprise a wavelength of approximately 850 nanometers and the second wavelength (λ₂) may comprise a wavelength of approximately 940 nanometers. In some examples, a spectral separation between the first wavelength (λ₁) and the second wavelength (λ₂) may be at least 0.4 nanometer, at least 0.8 nanometer, at least 5 nanometers, at least 20 nanometers, at least 40 nanometers, at least 100 nanometers, or at least 200 nanometers, the spectral separation being selected so as to allow the band-pass filter 108 to spectrally distinguish optical signals at the first wavelength (λ₁) from optical signals at the second wavelength (λ₂).

With reference to FIG. 2, an example first bi-directional optical communication module 102 (e.g., module 102) is illustrated. As shown, the first module 102 may include a substrate 106, a first band pass filter 108, a first optical transmitter 110, and a first optical receiver 112 that may each be supported by the substrate 106. The substrate 106 may, for example, be a printed circuit board (PCB) or other equivalent support structure compatible with operation of opto-electronic components. As such, the substrate 106 may define one or more electrical traces, wires, etc. configured to establish electrical communication between the opto-electronic components described herein. Although illustrated herein as a generally planar substrate 106, the present disclosure contemplates that the dimensions (e.g., size and/or shape) of the substrate 106 may vary based on the intended application of the module 102 and may, in some examples, refer to a plurality of substrates that are, for example, attached so as to collectively support the components described herein.

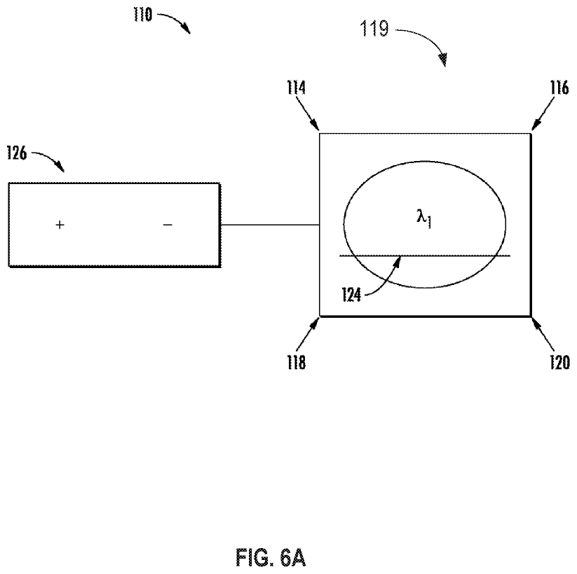

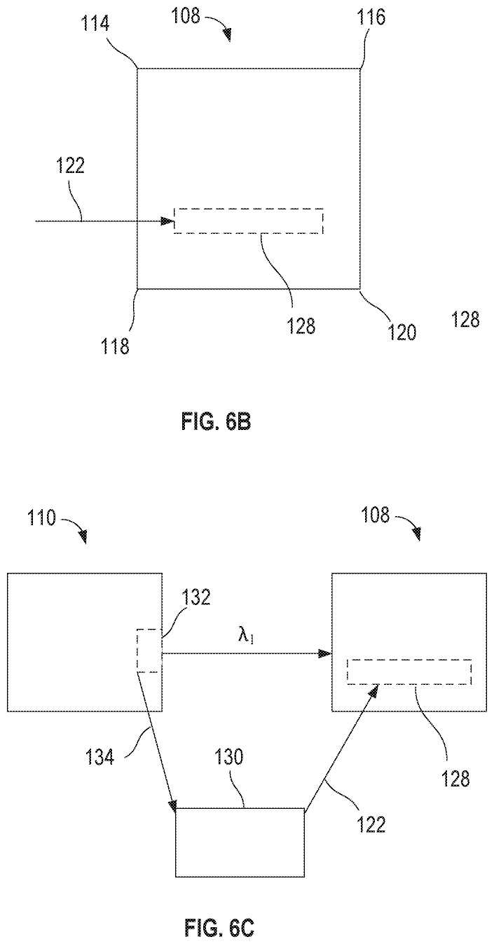

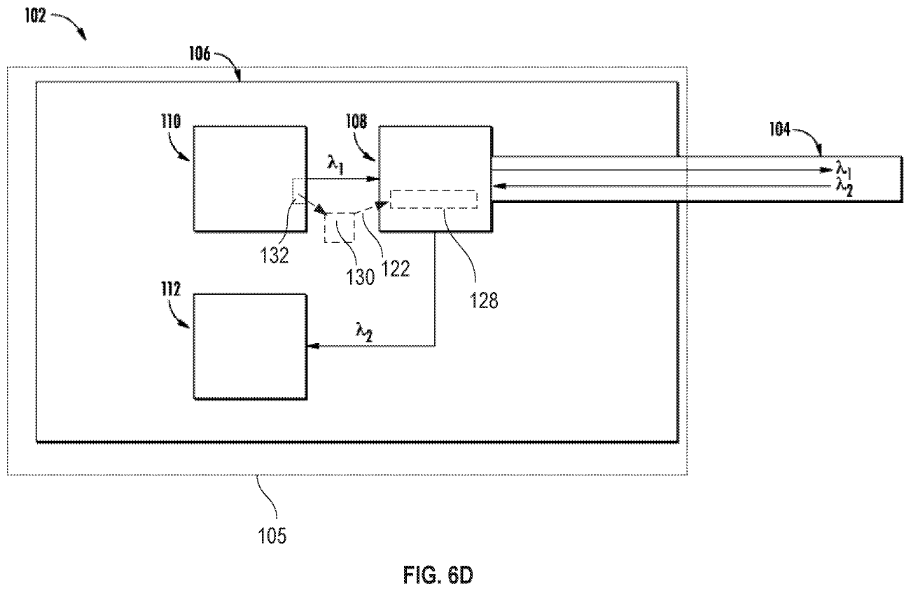

The first optical transmitter 110 may be supported by the substrate 106 and configured to generate optical signals. As described herein, the first optical transmitter 110 may be configured to generate optical signals having a first wavelength (λ₁) for transmission via the optical communication medium 104 for receipt by a corresponding optical receiver communicably coupled with the optical communication medium 104. In some examples, the first optical transmitter 110 may be a vertical-cavity surface-emitting laser (VCSEL) configured to generate optical signals having a first wavelength (λ₁). Although described with reference to a VCSEL based implementation of the first optical transmitter 110, the present disclosure contemplates that any device capable of generating optical signals may be used by the module 102. As described hereinafter with reference to FIG. 6A, in some examples, the first optical transmitter may include a band pass filter (e.g., a second band pass filter 119) that may be used to selectively generate optical signals. The term “selectively generate” may be used herein to refer to the ability to facilitate generate of optical signals at a particular or selected wavelength via dynamic or active modification of one or more characteristics or parameters of the example band pass filter acting as the first optical transmitter 110.

The first optical receiver 112 may be supported by the substrate 106 and configured to receive optical signals. As described herein, the first optical receiver 112 may be configured to receive optical signals having a second wavelength (λ₂), such as those received from the optical communication medium 104 that are generated by a corresponding optical transmitter communicably coupled with the optical communication medium 104. In some examples, the first optical receiver 112 may be a photodiode configured to receive optical signals having a second wavelength (λ₂). Although described with reference to a photodiode based implementation of the first optical receiver 112, the present disclosure contemplates that any device capable of receiving optical signals may be used by the module 102.

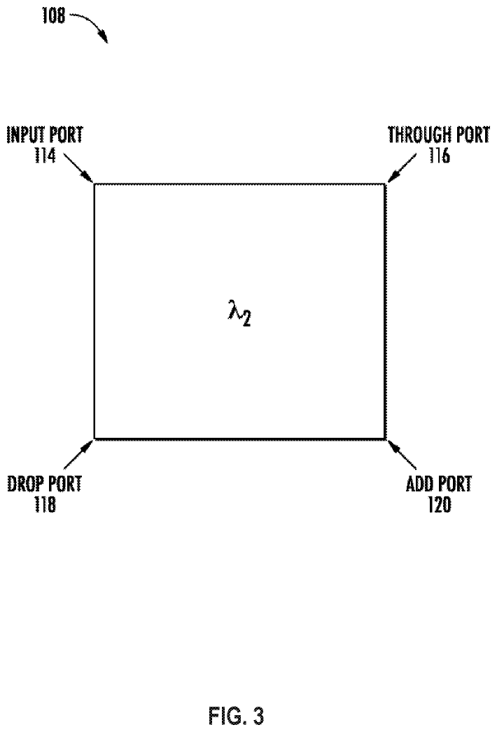

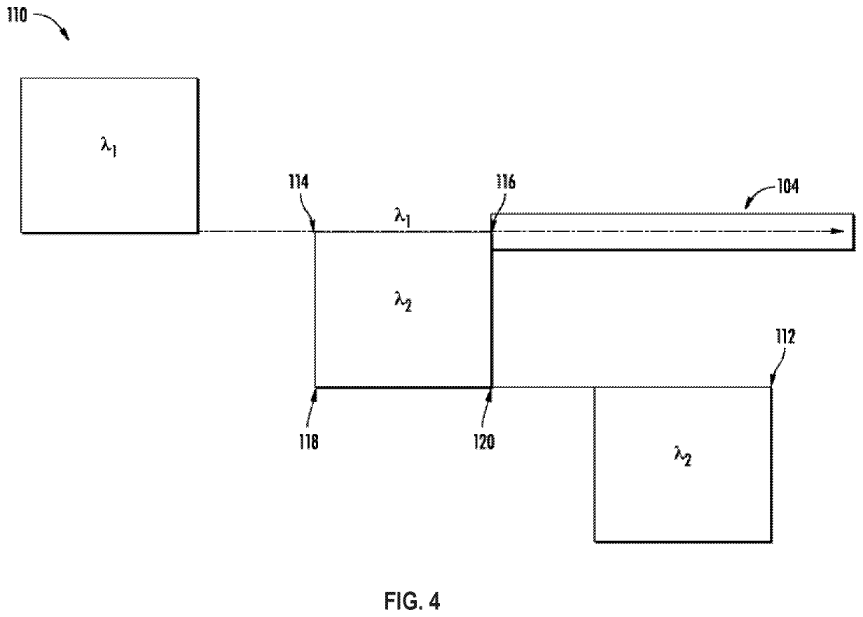

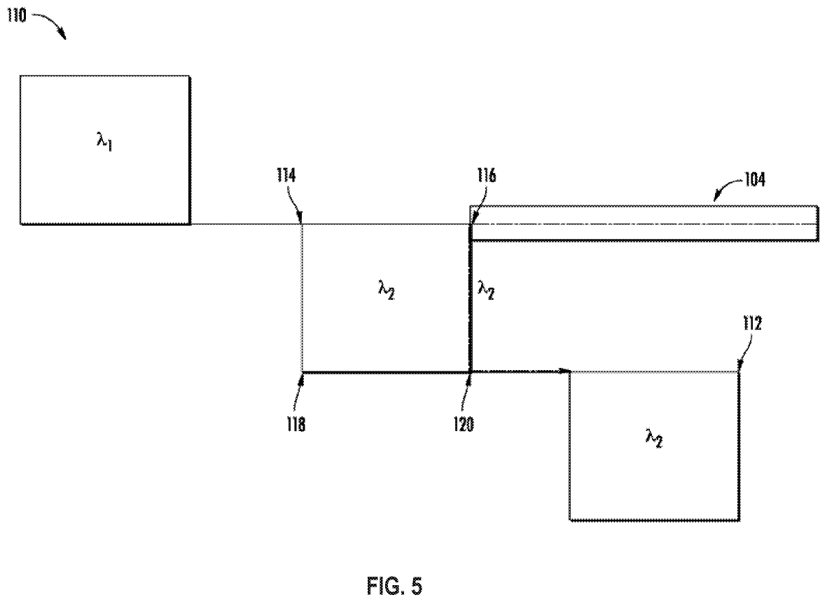

With reference to FIG. 3, the first bi-directional optical module 102 (e.g., module 102) may further include a first band pass filter 108, and the first optical transmitter 110 and the first optical receiver 112 may be communicably coupled with the first band pass filter 108. As described more fully hereinafter with reference to FIGS. 4-5, the first band pass filter 108 may be configured to pass optical signals received from the first optical transmitter 110 having the first wavelength (λ₁) into the optical communication medium 104 and may direct optical signals received from the optical communication medium 104 having the second wavelength (λ₂) into the first optical receiver 112.

As shown in FIG. 3, the first band pass filter 108 may include an input port 114, a through port 116, a drop port 118, and an add port 120. As would be evident to one of ordinary skill in the art in light of the present disclosure, the relative positioning between these ports 114, 116, 118, and 120 may be defined once any port is determined. Said differently, the input port 114 is disposed opposite the through port 116 and adjacent the drop port 118, and the add port 120 is disposed opposite the drop port 118 and adjacent the through port 116 in any configuration. As a non-limiting example, the first optical transmitter 110 may be communicably coupled with the input port 114 of the first band pass filter 108, the first optical receiver 112 may be communicably coupled with the add port 120 of the first band pass filter 108, and the optical communication medium 104 may be communicably coupled with the through port 116. The first band pass filter 108 may be associated with the second wavelength (λ₂) in that the first band pass filter 108 is configured to attenuate optical signals having the second wavelength (λ₂). As would be evident to one of ordinary skill in the art in light of the present disclosure, the first band pass filter 108 may be configured to pass through optical signals having any wavelength other than the second wavelength (λ₂) while the attenuation of the optical signals having the second wavelength (λ₂) results in re-direction of the optical signal to the adjacent ports as illustrated in FIGS. 4-5.

The input port 114, the through port 116, the drop port 118, and the add port 120 of the first band pass filter 108 may perform various functions in the wavelength-selective routing of optical signals through the first band pass filter 108. The input port 114 may serve as an ingress port through which an optical signal generated by the first optical transmitter 110 enters the first band pass filter 108 for routing. The through port 116 may serve as an egress port through which optical signals at wavelengths outside the attenuation band of the first band pass filter 108 (such as optical signals at the first wavelength (λ₁)) exit the first band pass filter 108 toward the optical communication medium 104, the through port 116 thereby providing a low-loss optical path for optical signals that propagate through the first band pass filter 108 substantially unaltered. The drop port 118 may serve as an egress port through which optical signals at wavelengths within the attenuation band of the first band pass filter 108 (such as optical signals at the second wavelength (λ₂)) are extracted, or ‘dropped,’ from a composite optical signal entering at the input port 114, the drop port 118 thereby providing an optical path for optical signals that are spectrally separated from the optical signals exiting at the through port 116. The add port 120 may serve as an ingress port through which an optical signal at a wavelength within the attenuation band of the first band pass filter 108 (such as an optical signal at the second wavelength (λ₂)) is introduced, or ‘added,’ to a composite optical signal exiting at the through port 116. In the bi-directional configuration described herein, the add port 120 may alternatively serve as an egress port through which optical signals at the second wavelength (λ₂) received from the optical communication medium 104 via the through port 116 are routed to the first optical receiver 112.

The through port 116 and the drop port 118 may therefore be distinguished in that the through port 116 carries optical signals that are spectrally passed by the first band pass filter 108 while the drop port 118 carries optical signals that are spectrally redirected by the first band pass filter 108. The drop port 118 and the add port 120 may be distinguished in that the drop port 118 outputs optical signals that have been spectrally separated from a composite optical signal entering at the input port 114, while the add port 120 receives or outputs optical signals at the wavelength within the attenuation band of the first band pass filter 108 in the configuration in which the first optical receiver 112 is communicably coupled to the add port 120. The corresponding ports 214, 216, 218, 220 of the third band pass filter 208 described elsewhere herein may be distinguished from one another in an analogous manner with respect to the first wavelength (λ₁), which is the wavelength within the attenuation band of the third band pass filter 208.

With reference to FIG. 4, operation of the module 102 in which the first optical transmitter 110 generates optical signals having the first wavelength (λ₁) is illustrated. As shown, the first band pass filter 108 may be configured to attenuate optical signals having the second wavelength (λ₂) such that optical signals that are not at the second wavelength (e.g., the first wavelength (λ₁)) pass therethrough. As such, the optical signals generated by the first optical transmitter having the first wavelength (λ₁) pass from the input port 114 to the through port 116 and into the optical communication medium 104. As described above, similar operation may occur with any port 114, 116, 118, 120 to which the first optical transmitter 110 is communicably coupled with the first band pass filter 108 (e.g., the first optical signals having the first wavelength (λ₁) would pass therethrough).

With reference to FIG. 5, operation of the module 102 in which the first optical receiver 112 receives optical signals having the second wavelength (λ₂) is illustrated. As shown, the first band pass filter 108 may be configured to attenuate optical signals having the second wavelength (λ₂) such that optical signals that are at the second wavelength are redirected from the port at which the optical signals are received to the adjacent port (e.g., from input port 114 to drop port 118 or from through port 116 to add port 120). As such, the optical signals received by the first band pass filter 108 from the optical communication medium 104 having the second wavelength (λ₂) are redirected from the through port 116 to the add port 120 and into the first optical receiver 112. As described above, similar operation may occur with any port 114, 116, 118, 120 to which the first optical receiver 112 is communicably coupled with the first band pass filter 108 (e.g., the second optical signals having the second wavelength (λ₂) would be redirected).

In operation of the first band pass filter 108 in the configuration described above, the first band pass filter 108 may receive at the through port 116, from the optical communication medium 104, a composite optical signal comprising both optical signals at the first wavelength (λ₁) and optical signals at the second wavelength (λ₂), where the optical signals at the first wavelength (λ₁) were generated by the first optical transmitter 110 of the first bi-directional optical communication module 102 and returned to the first band pass filter 108, or were generated by an additional optical source (not shown) coupled to the optical communication medium 104. The first band pass filter 108 spectrally separates the composite optical signal, passing the optical signals at the first wavelength (λ₁) through the through port 116 and redirecting the optical signals at the second wavelength (λ₂) to the add port 120 and into the first optical receiver 112, such that the first band pass filter 108 functions as a wavelength-selective routing element that simultaneously passes a first spectral component and redirects a second spectral component of a composite optical signal.

In doing so, the first bi-directional optical communication module 102 may provide for bi-directional optical communication via the optical communication medium 104 not found in traditional solutions. For example, the optical communication medium 104 may be configured to transmit optical signals having the first wavelength (λ₁) and the second wavelength (λ₂). As such, optical signals having the first wavelength (λ₁) and optical signals having the second wavelength (λ₂) may be transmitted simultaneously by the optical communication medium 104 to allow for bi-directional optical communication substantially reducing (e.g., by at least a factor of two) the routing burdens associated with conventional systems.

With reference to FIG. 6A, an example instance in which the first optical transmitter 110 includes a second band pass filter 119 to facilitate generation of optical signals is illustrated. As shown, the first optical transmitter 110 may, in some instances, include a voltage source 126 coupled with the first optical transmitter and a wavelength modification element 124. The wavelength modification element may be a resistor, diode, and/or the like that may operate to selectively modify a material index of the second band pass filter operating as the first optical transmitter 110. For example, the wavelength modification element 124 may locally modify the temperature of the second band pass filter so as to modify the material index of the second band pass filter to modify the wavelength at which the second band pass filter attenuates optical signals. In doing so, the second band pass filter operating as the first optical transmitter 110 may encode data in the first wavelength (e.g., by selectively passing signals having the first wavelength).

FIG. 6B illustrates an example instance of a tunable band pass filter 108 of a first bi-directional optical communication module in accordance with one or more examples of the present disclosure. A band pass filter 108 may include an input port 114, a through port 116, a drop port 118, and an add port 120, as described elsewhere herein. The relative positioning between these ports 114, 116, 118, and 120 may vary. The band pass filter 108 may be configured to attenuate optical signals having the second wavelength (λ₂). The first band pass filter 108 may be configured to pass through optical signals having any wavelength other than the second wavelength (λ₂) while the attenuation of the optical signals having the second wavelength (λ₂) results in re-direction of the optical signal to the adjacent ports.

A tunable band pass filter 108 may include a wavelength modification element 128. The wavelength modification element 128 may locally modify a characteristic, such as the temperature, of the band pass filter so as to modify a material index of the band pass filter. Modifying the material index may result in modification of the wavelength at which the band pass filter attenuates optical signals. In doing so, the band pass filter 108 operating as the first optical transmitter 110 may encode data in the first wavelength (e.g., by selectively passing signals having the first wavelength).

The material index modified by the wavelength modification element 128 may be a material refractive index of one or more optical materials that form, or are disposed adjacent to, the band pass filter 108. In some examples, the band pass filter 108 may be implemented as a wavelength-selective optical resonator, such as a micro-ring resonator, a micro-disk resonator, a Mach-Zehnder interferometer-based filter, an arrayed waveguide grating (AWG), a Bragg grating filter, or a cascaded combination thereof, fabricated in a waveguide material system. The waveguide material system may comprise silicon, silicon nitride, silicon oxynitride, silica, lithium niobate, indium phosphide, gallium arsenide, a polymer waveguide material, or a combination thereof, on a suitable substrate such as a silicon-on-insulator (SOI) substrate, a silicon nitride-on-insulator substrate, or another photonic integrated circuit substrate. The waveguide material system and suitable substrate described above may be referred to as a silicon photonics substrate when the waveguide material system comprises silicon, silicon nitride, or silicon oxynitride on a silicon-on-insulator substrate or a silicon nitride-on-insulator substrate. In some examples, the substrate 106 of the first bi-directional optical communication module 102 comprises a silicon photonics substrate. In some examples, the v-groove edge coupler of the fiber I/O 113 may be fabricated into the silicon photonics substrate. The V-shaped groove may be formed by anisotropic etching of the silicon photonics substrate, in which a crystallographic etch stop produces well-defined sidewalls that receive and align the end of the optical communication medium 104 relative to a waveguide end-facet defined in the silicon photonics substrate.

The wavelength at which the band pass filter 108 attenuates optical signals (and, correspondingly, the wavelengths passed to the through port 116 or redirected to the drop port 118 or add port 120) may be a function of the effective refractive index of the optical mode propagating within the waveguide structure of the band pass filter 108. For a resonator-based band pass filter, the resonant wavelength λᵣₑₛ may satisfy a resonance condition in which the optical path length of the resonator is an integer multiple of the wavelength, such that λᵣₑₛ is proportional to the product of the effective refractive index n_{eff} and the physical path length L of the resonator. A change Δn_{eff} in the effective refractive index may produce a corresponding change Δλᵣₑₛ in the resonant wavelength, shifting the spectral position of the pass-band of the band pass filter 108.

In some examples, the wavelength modification element 128 may be a thermal heating element. The thermal heating element may locally modify a temperature of the tunable band pass filter, which may adjust the material refractive index. The thermal heating element may comprise at least one resistor or diode. In some examples, the thermal heating element may include a thermoelectric cooler (TEC), resistive foil/ceramic heaters, thermistor/resistive heaters, indium tin oxide (ITO) coatings, or optically clear/transparent heaters. A thermal heating element may allow for precise temperature control. In some examples, the thermal heating elements may modify the local temperature of the band pass filter to within 5 degrees, 3 degrees, 2 degrees, 1 degree, 0.5 degrees, 0.1 degrees, 0.05 degrees, or 0.01 degrees C. IN some examples, the thermal heating element may alter (e.g., increase or decrease) the local temperature of the band pass filter by at least 30 degrees, 20 degrees, 15 degrees, 10 degrees, 5 degrees, 3 degrees, 2 degrees, 1 degree, 0.5 degrees, or 0.1 degrees C.

The adjustment of the material refractive index by the thermal heating element may rely on a thermo-optic effect, by which the refractive index of the waveguide material varies as a function of temperature. The magnitude of the wavelength shift achievable by the thermal heating element may be a function of the waveguide material, a resonator geometry, and a temperature range over which the thermal heating element may operate.

The thermal heating element may be disposed in thermal proximity to the waveguide or resonator structure of the band pass filter 108 so as to deliver localized heat to the optical mode volume while limiting heat transfer to adjacent components. In some examples, the thermal heating element may comprise a resistive heater deposited on or above the waveguide cladding, separated from the waveguide core by a thermal isolation layer configured to allow efficient heat delivery to the waveguide while maintaining electrical isolation. In some examples, thermal isolation trenches, undercuts, or air gaps may be provided adjacent to the band pass filter 108 to confine heat and reduce the thermal time constant and power consumption of the thermal heating element. In some examples, the thermal heating element may be configured to consume less than 50 milliwatts, less than 20 milliwatts, less than 10 milliwatts, less than 5 milliwatts, or less than 1 milliwatt per nanometer of wavelength shift.

The wavelength modification element 128 may respond to a control signal 122. The control signal may be provided from a controller. The controller may comprise a dedicated microcontroller, a digital signal processor, a field-programmable gate array (FPGA), an application-specific integrated circuit (ASIC), or a control block integrated within an electrical-to-optical driver integrated circuit. In some examples, the electrical-to-optical driver integrated circuit may be co-packaged with the band pass filter 108. The controller may be disposed on the same substrate as the band pass filter 108, within the same housing as the bi-directional optical communication module, or at a location remote from the module and communicatively coupled to the module via an electrical interface. In some examples, the controller may be configured to receive one or more input signals representative of an operating condition of the module and to generate the control signal 122 as a function of the one or more input signals.

In some examples, the first bi-directional optical communication module 102 comprises a housing that at least partially encloses the substrate 106, the tunable band pass filter 108, the first optical transmitter 110, and the first optical receiver 112. In some examples, the electrical-to-optical driver integrated circuit is co-packaged with the substrate 106 within the housing. Co-packaging the substrate 106 with the electrical-to-optical driver integrated circuit within the housing may comprise mounting the substrate 106 and the electrical-to-optical driver integrated circuit on a common package substrate, an interposer, or a carrier substrate enclosed by the housing. Co-packaging the substrate 106 may comprise flip-chip bonding the electrical-to-optical driver integrated circuit to the substrate 106. In some examples, co-packaging the substrate 106 may comprise wire bonding the electrical-to-optical driver integrated circuit to the substrate 106. In some examples, co-packaging the substrate 106 may comprise another co-packaging arrangement. The housing may comply with a multi-source agreement (MSA) form factor described elsewhere herein or with a co-packaged optics (CPO) form factor. Co-packaging the electrical-to-optical driver integrated circuit with the substrate 106 within the housing may reduce electrical signal path length between the electrical-to-optical driver integrated circuit and the first optical transmitter 110, may reduce electromagnetic interference, and may improve signal integrity at high data rates.

The one or more input signals received by the controller may include, by way of example and not limitation: a temperature signal from a temperature sensor (such as a thermistor, resistance temperature detector (RTD), or on-chip temperature-sensing diode) disposed in thermal proximity to the first optical transmitter 110 or to the band pass filter 108; an optical power signal from a monitor photodiode optically coupled to a tap of the waveguide at or near an output of the first optical transmitter 110 or at the drop port 118 or through port 116 of the band pass filter 108; a wavelength locker signal from a wavelength-discrimination element (such as an etalon or a pair of detuned filters with a known spectral response); a supply voltage or bias current signal from the first optical transmitter 110; or an external command signal from a host system.

The control signal 122 may affect a voltage source that may affect operation of the wavelength modification element. The control signal may affect operation of a thermal heating element that may function as a wavelength modification element. The control signal may result in the adjustment of the material refractive index. This may compensate for thermal drift in the first wavelength generated by the first optical transmitter. Dynamic adjustment of the material refractive index may shift a center wavelength of a pass-band of the tunable band pass filter. The tunable band pass filter may dynamically alter a spectral transfer function of the tunable band pass filter by shifting the center wavelength of the pass-band to maintain spectral alignment with the first wavelength (λ₁) and/or the second wavelength (λ₂).

In some examples, in which the wavelength modification element 128 may comprise a resistive thermal heating element, the control signal 122 may set or modulate a voltage applied across the resistive heating element or a current driven through the resistive heating element, such that the electrical power dissipated in the resistive heating element may be controlled according to P=V²/R or P=I²R, where R is the resistance of the resistive heating element. The dissipated power, in turn, may determine the temperature rise ΔT of the band pass filter 108. The temperature rise ΔT may produce the refractive index change as described elsewhere herein, which may produce the resonant wavelength shift Δλᵣₑₛ, thereby shifting the center wavelength of the pass-band of the band pass filter 108.

In some examples, the controller may generate the control signal 122 in an open-loop configuration, in which the control signal 122 may be set based on a predetermined calibration relating a commanded pass-band center wavelength to a corresponding electrical drive level for the wavelength modification element 128. The calibration may be stored in a non-volatile memory accessible to the controller and may be determined during factory test or during an initialization routine of the module.

In some examples, the controller may generate the control signal 122 in a closed-loop configuration, in which the controller receives a feedback signal representative of an alignment between the pass-band of the band pass filter 108 and the first wavelength (λ1) or the second wavelength (λ₂), and adjusts the control signal 122 so as to drive an error between a target alignment and the feedback signal toward zero. The feedback signal may be generated, for example, by a monitor photodiode coupled to the drop port 118 or the through port 116, such that the monitor photodiode produces a photocurrent proportional to the optical power present at the monitored port. The controller adjusts the control signal 122 to maximize or minimize the photocurrent according to which port corresponds to the aligned pass-band.

Thermal drift in the first wavelength (λ₁) generated by the first optical transmitter 110 may arise from changes in ambient temperature, self-heating of the first optical transmitter 110, aging of the first optical transmitter 110, or other environmental or operational factors. For a semiconductor laser source such as a vertical-cavity surface-emitting laser (VCSEL), the emission wavelength typically drifts with junction temperature at a rate of approximately 0.06 to 0.1 nanometer per degree Celsius. Without compensation, such drift may cause the first wavelength (λ₁) to move out of spectral alignment with the pass-band of the band pass filter 108, resulting in increased insertion loss, reduced spectral crosstalk isolation, or link failure. By adjusting the control signal 122 to modify the material refractive index of the band pass filter 108, the controller may shift the pass-band center wavelength to track the drifted first wavelength (λ₁) and maintain spectral alignment. In some examples, the controller may additionally or alternatively adjust a second control signal provided to a wavelength modification element associated with the first optical transmitter 110 (such as the wavelength modification element 124 of FIG. 6A) so as to stabilize the first wavelength (λ₁) itself.

In some examples, the controller may be configured to shift the pass-band center wavelength of the band pass filter 108 over a tuning range of at least 0.5 nanometer, at least 1 nanometer, at least 2 nanometers, at least 5 nanometers, at least 10 nanometers, or at least 20 nanometers, so as to accommodate thermal drift of the first optical transmitter 110 across an operating temperature range of the module. In some examples, the operating temperature range may span from 0 degrees Celsius to 70 degrees Celsius, from minus 5 degrees Celsius to 85 degrees Celsius, or another range consistent with the intended deployment environment of the module.

In some examples, the controller may dynamically alter the spectral transfer function of the band pass filter 108 not only by shifting the center wavelength of the pass-band but also by adjusting a bandwidth, a roll-off characteristic, or an extinction ratio of the pass-band, where the band pass filter 108 may be implemented as a multi-stage or tunable-bandwidth filter (such as a cascaded ring resonator with independently tunable stages). The dynamic alteration of the spectral transfer function may be used to accommodate multi-wavelength laser sources (such as a mode-locked comb laser or a bank of lasers) that generate a set of discrete wavelength lines spanning a spectral band, such that the pass-band of the band pass filter 108 may be configured to encompass the entire spectral band corresponding to the first wavelength (λ₁) or the second wavelength (λ₂).

FIG. 6C illustrates an example of a control of the tunable band pass filter 108 of a first bi-directional optical communication module in accordance with one or more examples of the present disclosure. As described, a first optical transmitter 110 may provide an optical signal to the tunable band pass filter 108. The optical transmitter may be provided at a first wavelength (λ₁). As described, thermal drift or other effects may occur with the optical transmitter that may cause the first wavelength to shift or move out of spectral alignment with the tunable band pass filter 108.

One or more monitors 132 or sensors may be provided that may generate one or more feedback signals representative of an operating condition of the first optical transmitter 110, the tunable band pass filter 108, or the optical signal propagating therebetween, and may provide the one or more feedback signals 134 to a controller 130 for use in generating the control signal 122. A monitor may include a monitor photodiode, a temperature sensor (such as a thermistor, a resistance temperature detector (RTD), or an on-chip temperature-sensing diode), a wavelength locker comprising one or more wavelength-discrimination elements (such as an etalon or a pair of detuned reference filters), an optical tap coupled to the waveguide, a current sensor configured to sense a bias current of the first optical transmitter 110, a voltage sensor configured to sense a supply voltage of the first optical transmitter 110, or a combination of two or more of the foregoing. In some examples, a monitor may be provided on a first optical transmitter to sense one or more conditions of the first optical transmitter. A monitor may sense one or more characteristics of an optical signal from the first optical transmitter to the tunable band pass filter, such as a wavelength of the optical signal. The monitor may be located on, within, or adjacent to the first optical transmitter 110; on or adjacent to the tunable band pass filter 108; optically coupled to the drop port 118, the through port 116, the input port 114, or the add port 120 of the tunable band pass filter 108 by way of a waveguide tap configured to divert a fraction of the optical power at the monitored port to the monitor; on the substrate 106 supporting the first optical transmitter 110 and the tunable band pass filter 108; co-packaged with the first optical transmitter 110 and the tunable band pass filter 108 within a housing of the bi-directional optical communication module; or at a location within the module positioned to sense the condition of interest.

Data from the one or more monitors 132 may be provided to a controller 130. The data may be provided to the controller 130 as an analog signal (such as a voltage or current output of the monitor), as a digital signal converted from an analog monitor output by an analog-to-digital converter (ADC), or as a digital signal transmitted over a serial interface (such as I²C, SPI, or MDIO). The controller 130 may sample the data from the one or more monitors 132 at a sampling rate sufficient to track a rate of change of the operating condition being monitored, which may be, by way of example, a sampling rate of at least 1 Hz, at least 10 Hz, at least 100 Hz, at least 1 kHz, or at least 10 kHz. The controller 130 may process the data from the one or more monitors 132 according to a control algorithm stored in a memory accessible to the controller 130, the control algorithm configured to determine, based on the data, a target value for the control signal 122 that drives an error between the monitored operating condition and a target operating condition toward zero. The control algorithm may comprise a proportional-integral (PI) algorithm, a proportional-integral-derivative (PID) algorithm, a dither-based algorithm (in which the controller 130 applies a small perturbation to the control signal 122 and observes a corresponding change in the monitor data to determine a direction of adjustment), a model-predictive control (MPC) algorithm, a lookup-table-based algorithm, or a combination thereof. In some examples, the controller 130 may further receive configuration data (such as a target pass-band center wavelength, a target operating temperature, or a target output power) from a host system via an external command interface, and may incorporate the configuration data into the determination of the target value for the control signal 122.

The controller 130 may send one or more control signals 122 to a wavelength modification element 128 of the tunable band pass filter. The control signal may control the wavelength modification element, which may result in an adjustment of a material refractive index, as described elsewhere herein. In some examples, the wavelength modification element may be a thermal heating element, and the control signal may set or modulate an electrical drive level applied to the thermal heating element so as to control an amount of electrical power dissipated in the thermal heating element, the dissipated power producing a corresponding temperature change in the tunable band pass filter 108, the temperature change producing a corresponding change in the material refractive index of the tunable band pass filter 108 via the thermo-optic effect, and the change in the material refractive index producing a corresponding shift in the center wavelength of the pass-band of the tunable band pass filter 108. The electrical drive level may be expressed as a voltage applied across the thermal heating element, a current driven through the thermal heating element, a duty cycle of a pulse-width-modulated (PWM) waveform applied to the thermal heating element, or a digital command value transmitted to a driver circuit coupled to the thermal heating element. The driver circuit may be configured to convert the control signal 122 into the electrical drive level applied to the thermal heating element, and may be integrated within the controller 130, integrated within an electrical-to-optical driver integrated circuit co-packaged with the tunable band pass filter 108, or implemented as a discrete component. In some examples, the controller 130 may send a plurality of control signals 122 to a corresponding plurality of wavelength modification elements 128, where the tunable band pass filter 108 comprises a multi-stage filter (such as a cascaded ring resonator filter with independently tunable stages), so as to independently adjust respective stages of the tunable band pass filter 108 and thereby adjust not only the center wavelength of the pass-band but also a bandwidth, a roll-off characteristic, or an extinction ratio of the pass-band.

In operation, the controller 130 may continuously or periodically receive data from the one or more monitors 132, determine an alignment condition between the pass-band of the tunable band pass filter 108 and the first wavelength (λ₁), generate the control signal 122 based on the determined alignment condition, and send the control signal 122 to the wavelength modification element 128, such that the tunable band pass filter 108 is dynamically maintained in spectral alignment with the first wavelength (λ₁) as the first wavelength (λ₁) drifts due to thermal, aging, or other operational effects. The controller 130 may perform an analogous control function with respect to the second wavelength (λ₂), either by way of the same control loop (where the monitor 132 senses an alignment condition with respect to the second wavelength (λ₂)) or by way of a separate control loop with a separate monitor and a separate control signal. In some examples, the controller 130 may be further configured to execute an initialization routine during start-up of the module, in which the controller 130 sweeps the control signal 122 across a range of values, records the corresponding monitor data at each value, identifies a value of the control signal 122 that corresponds to a target alignment condition, and uses the identified value as an initial operating point for the control signal 122 during subsequent operation of the module.

FIG. 6D illustrates an optical communication module, according to some examples. The optical communication module may include a substrate 106, a first optical transmitter 110 supported by the substrate and configured to generate a first optical signal having a first wavelength, and a first optical receiver 112 supported by the substrate and configured to receive a second optical signal having a second wavelength distinct from the first wavelength.

The optical communication module may further include a band pass filter 108 supported by the substrate and communicably coupled to the first optical transmitter, the first optical receiver, and an optical port. The band pass filter may be a tunable band pass filter that may include a wavelength modification element 128 configured to dynamically adjust a material refractive index of the tunable band pass filter in response to a control signal 122. The dynamic adjustment configures the tunable band pass filter to: pass the first optical signal from the first optical transmitter to the optical port; and direct the second optical signal from the optical port into the first optical receiver.

The control signal may be provided from a controller 130 which may receive data from one or more monitors 132, as described elsewhere herein. The control signal 122 may be provided by the controller 130. The controller 130 may be an electrical-to-optical driver integrated circuit (referenced by 130) that generates the control signal 122. The controller may be separate from the first optical transmitter 110, the first optical receiver 112, and/or band pass filter, or may be incorporated as part of the first optical transmitter 110, the first optical receiver 112, and/or band pass filter.

In some examples, the first optical communication module 102 comprises a housing 105 that at least partially encloses the substrate 106, the tunable band pass filter 108, the first optical transmitter 110, and the first optical receiver 112.

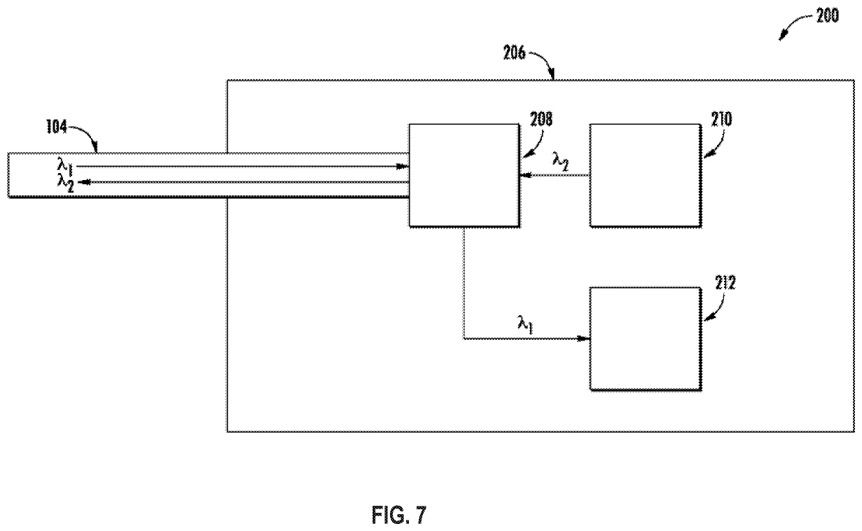

With reference to FIG. 7, an example second bi-directional optical communication module 200 (e.g., module 200) is illustrated. As shown, the second module 200 may include a substrate 206, a third band pass filter 208, a second optical transmitter 210, and a second optical receiver 212 that may each be supported by the substrate 206. The substrate 206 may, for example, be a printed circuit board (PCB) or other equivalent support structure compatible with operation of opto-electronic components. As such, the substrate 206 may define one or more electrical traces, wires, etc. configured to establish electrical communication between the opto-electronic components described herein. Although illustrated herein as a generally planar substrate 206, the present disclosure contemplates that the dimensions (e.g., size and/or shape) of the substrate 206 may vary based on the intended application of the module 200 and may, in some examples, refer to a plurality of substrates that are, for example, attached so as to collectively support the components described herein.

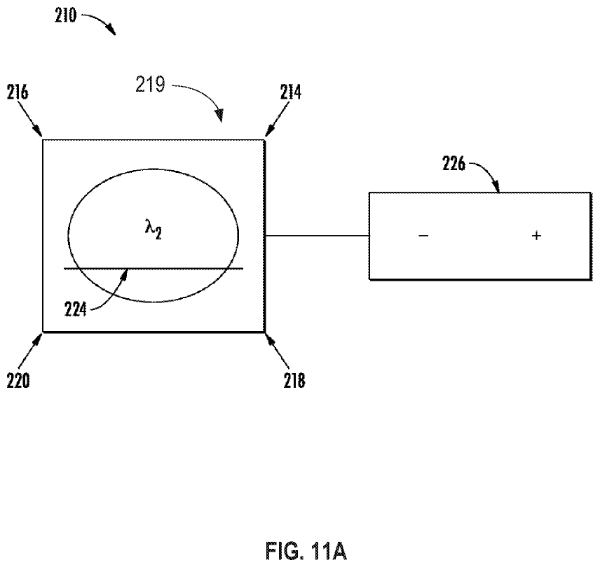

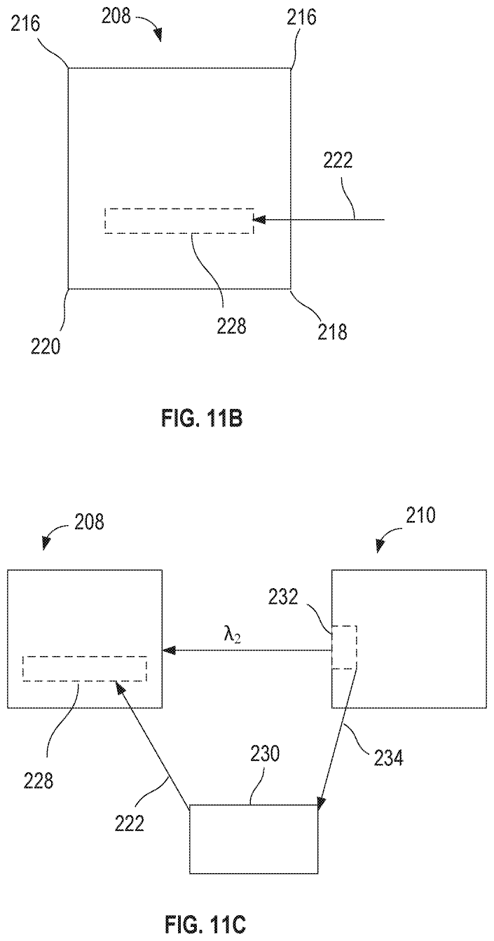

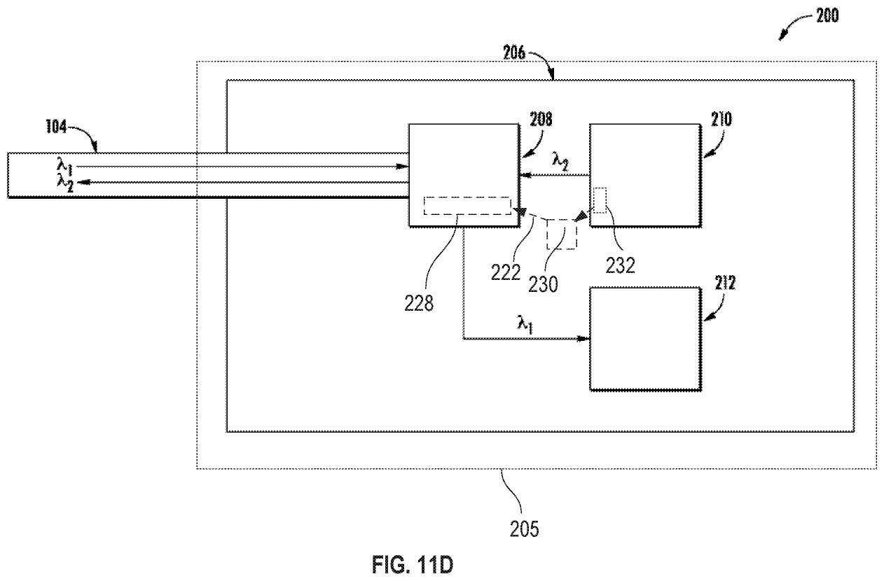

The second optical transmitter 210 may be supported by the substrate 206 and configured to generate optical signals. As described herein, the second optical transmitter 210 may be configured to generate optical signals having a second wavelength (λ₂) for transmission via the optical communication medium 104 for receipt by a corresponding optical receiver (e.g., first optical receiver 112) communicably coupled with the optical communication medium 104. In some examples, the second optical transmitter 210 may be a vertical-cavity surface-emitting laser (VCSEL) configured to generate optical signals having a second wavelength (λ₂). Although described with reference to a VCSEL based implementation of the second optical transmitter 210, the present disclosure contemplates that any device capable of generating optical signals may be used by the module 200. As described hereinafter with reference to FIG. 11A, in some examples, the second optical transmitter may include a band pass filter (e.g., a fourth band pass filter 219) that may be used to selectively generate optical signals.

The second optical receiver 212 may be supported by the substrate 206 and configured to receive optical signals. As described herein, the second optical receiver 212 may be configured to receive optical signals having a first wavelength (λ₁), such as those received from the optical communication medium 104 that are generated by a corresponding optical transmitter (e.g., first optical transmitter 110) communicably coupled with the optical communication medium 104. In some examples, the second optical receiver 212 may be a photodiode configured to receive optical signals having a first wavelength (λ₁). Although described with reference to a photodiode based implementation of the second optical receiver 212, the present disclosure contemplates that any device capable of receiving optical signals may be used by the module 200.

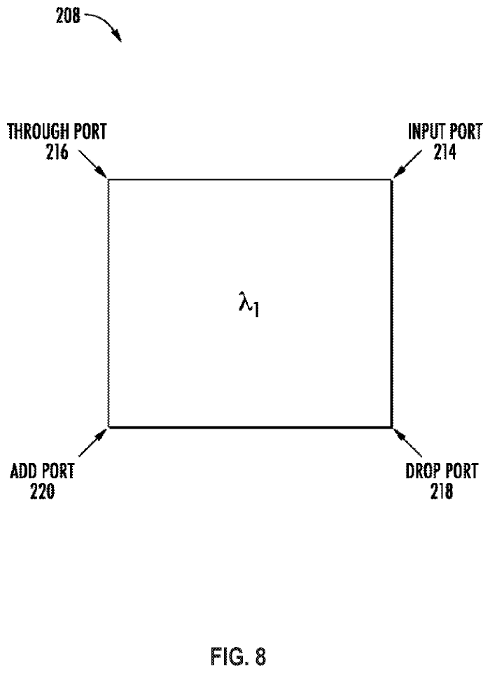

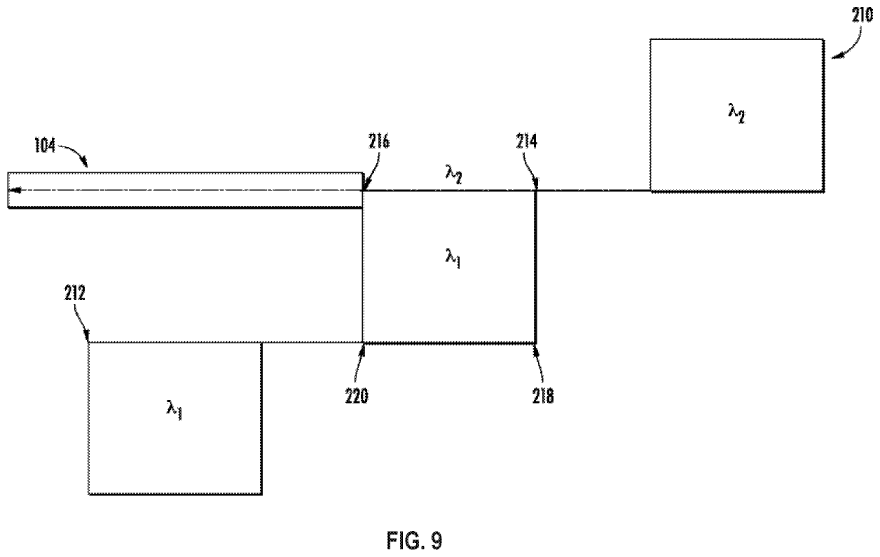

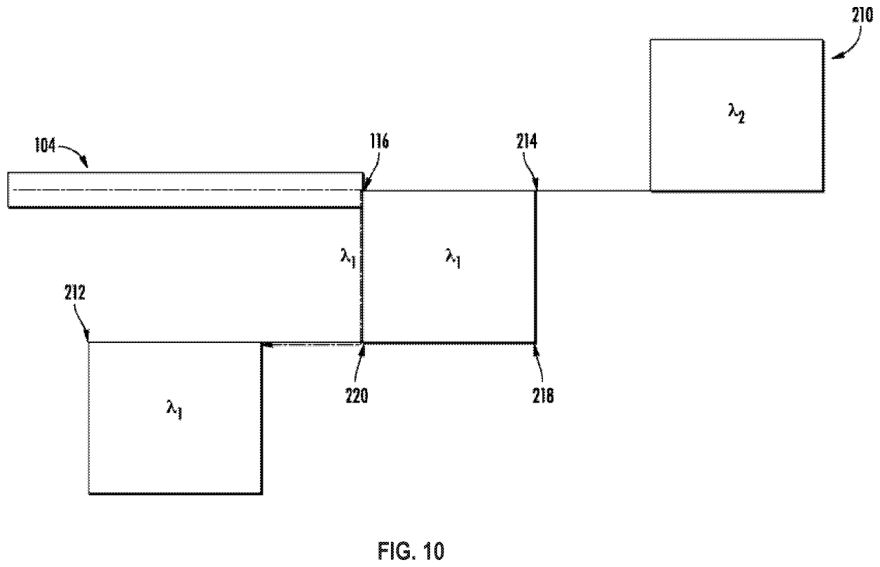

With reference to FIG. 8, the second bi-directional optical module 200 (e.g., module 200) may further include a third band pass filter 208, and the second optical transmitter 210 and the second optical receiver 212 may be communicably coupled with the third band pass filter 208. As described more fully hereinafter with reference to FIGS. 9-10, the third band pass filter 208 may be configured to pass optical signals received from the second optical transmitter 210 having the second wavelength (λ₂) into the optical communication medium 104 and may direct optical signals received from the optical communication medium 104 having the first wavelength (λ₁) into the second optical receiver 212.

As shown in FIG. 8, the third band pass filter 208 may include an input port 214, a through port 216, a drop port 218, and an add port 220. As would be evident to one of ordinary skill in the art in light of the present disclosure, the relative positioning between these ports 214, 216, 218, and 220 may be defined once any port is determined. Said differently, the input port 214 is disposed opposite the through port 216 and adjacent the drop port 218, and the add port is disposed opposite the drop port 218 and adjacent the through port 216 in any configuration. As a non-limiting example, the second optical transmitter 210 may be communicably coupled with the input port 214 of the third band pass filter 208, the second optical receiver 212 may be communicably coupled with the add port 220 of the third band pass filter 208, and the optical communication medium 104 may be communicably coupled with the through port 216. The third band pass filter 208 may be associated with the first wavelength (λ₁) in that the third band pass filter 208 is configured to attenuate optical signals having the first wavelength (λ₁). As would be evident to one of ordinary skill in the art in light of the present disclosure, the third band pass filter 208 may be configured to pass through optical signals having any wavelength other than the first wavelength (λ₁) while the attenuation of the optical signals having the first wavelength (λ₁) results in re-direction of the optical signal to the adjacent ports as illustrated in FIGS. 9-10.

With reference to FIG. 9, operation of the module 200 in which the second optical transmitter 210 generates optical signals having the second wavelength (λ₂) is illustrated. As shown, the third band pass filter 208 may be configured to attenuate optical signals having the first wavelength (λ₁) such that optical signals that are not at the first wavelength (e.g., the second wavelength (λ₂)) pass therethrough. As such, the optical signals generated by the second optical transmitter having the second wavelength (λ₂) pass from the input port 214 to the through port 216 and into the optical communication medium 104. As described above, similar operation may occur with any port 214, 216, 218, 220 to which the second optical transmitter 210 is communicably coupled with the third band pass filter 208 (e.g., the second optical signals having the second wavelength (λ₂) would pass therethrough).

With reference to FIG. 10, operation of the module 200 in which the second optical receiver 212 receives optical signals having the first wavelength (λ₁) is illustrated. As shown, the third band pass filter 208 may be configured to attenuate optical signals having the first wavelength (λ₁) such that optical signals that are at the first wavelength are redirected from the port at which the optical signals are received to the adjacent port (e.g., from input port 214 to drop port 218 or from through port 216 to add port 220). As such, the optical signals received by the third band pass filter 208 from the optical communication medium 104 having the first wavelength (λ₁) are redirected from the through port 216 to the add port 220 and into the second optical receiver 212. As described above, similar operation may occur with any port 214, 216, 218, 220 to which the second optical receiver 212 is communicably coupled with the third band pass filter 208 (e.g., the first optical signals having the first wavelength (λ₁) would be redirected).

In operation of the third band pass filter 208 in the configuration described above, the third band pass filter 208 may receive at the through port 216, from the optical communication medium 104, a composite optical signal comprising both optical signals at the first wavelength (λ₁) and optical signals at the second wavelength (λ₂). The third band pass filter 208 spectrally separates the composite optical signal, passing the optical signals at the second wavelength (λ₂) through the through port 216 and redirecting the optical signals at the first wavelength (λ₁) to the add port 220 and into the second optical receiver 212.

As described above, the second bi-directional optical communication module 200 may provide for bi-directional optical communication via the optical communication medium 104 not found in traditional solutions. For example, the optical communication medium 104 may be configured to transmit optical signals having the first wavelength (λ₁) and the second wavelength (λ₂). As such, optical signals having the first wavelength (λ₁) and optical signals having the second wavelength (λ₂) may be transmitted simultaneously by the optical communication medium 104 to allow for bi-directional optical communication substantially reducing (e.g., by at least a factor of two) the routing burdens associated with conventional systems.

With reference to FIG. 11A, an example instance in which the second optical transmitter 210 includes a fourth band pass filter 219 to facilitate generation of optical signals is illustrated. As shown, the second optical transmitter 210 may, in some instances, include a voltage source 226 coupled with the second optical transmitter and a wavelength modification element 224. The wavelength modification element may be a resistor, diode, and/or the like that may operate to selectively modify a material index of the fourth band pass filter operating as the second optical transmitter 210. For example, the wavelength modification element 224 may locally modify the temperature of the fourth band pass filter so as to modify the material index of the fourth band pass filter to modify the wavelength at which the fourth band pass filter attenuates optical signals. In doing so, the fourth band pass filter operating as the second optical transmitter 210 may encode data in the second wavelength (e.g., by selectively passing signals having the second wavelength).

FIG. 11B illustrates an example instance of a tunable band pass filter 208 of a second bi-directional optical communication module in accordance with one or more examples of the present disclosure. A band pass filter 208 may include an input port 214, a through port 216, a drop port 218, and an add port 220, as described elsewhere herein. The relative positioning between these ports 214, 216, 218, and 220 may vary. The band pass filter 208 may be configured to attenuate optical signals having the first wavelength (λ₁). The band pass filter 208 may be configured to pass through optical signals having any wavelength other than the first wavelength (λ₁) while the attenuation of the optical signals having the first wavelength (λ₁) results in re-direction of the optical signal to the adjacent ports.

A tunable band pass filter 208 may include a wavelength modification element 228. The wavelength modification element 228 may locally modify a characteristic, such as the temperature, of the band pass filter so as to modify a material index of the band pass filter. Modifying the material index may result in modification of the wavelength at which the band pass filter attenuates optical signals. In doing so, the band pass filter 208 operating as the second optical transmitter 210 may encode data in the second wavelength (e.g., by selectively passing signals having the second wavelength).

The material index modified by the wavelength modification element 228 may be a material refractive index of one or more optical materials that form, or are disposed adjacent to, the band pass filter 208. In some examples, the band pass filter 208 may be implemented as a wavelength-selective optical resonator, such as a micro-ring resonator, a micro-disk resonator, a Mach-Zehnder interferometer-based filter, an arrayed waveguide grating (AWG), a Bragg grating filter, or a cascaded combination thereof, fabricated in a waveguide material system. The waveguide material system may comprise silicon, silicon nitride, silicon oxynitride, silica, lithium niobate, indium phosphide, gallium arsenide, a polymer waveguide material, or a combination thereof, on a suitable substrate such as a silicon-on-insulator (SOI) substrate, a silicon nitride-on-insulator substrate, or another photonic integrated circuit substrate.

The wavelength at which the band pass filter 208 attenuates optical signals (and, correspondingly, the wavelengths passed to the through port 216 or redirected to the drop port 218 or add port 220) may be a function of the effective refractive index of the optical mode propagating within the waveguide structure of the band pass filter 208. For a resonator-based band pass filter, the resonant wavelength λᵣₑₛ may satisfy a resonance condition in which the optical path length of the resonator may be an integer multiple of the wavelength, such that λᵣₑₛ may be proportional to the product of the effective refractive index n_{eff} and the physical path length L of the resonator. A change Δn_{eff} in the effective refractive index may produce a corresponding change Δλᵣₑₛ in the resonant wavelength, shifting the spectral position of the pass-band of the band pass filter 208.

In some examples, the wavelength modification element 228 may be a thermal heating element. The thermal heating element may locally modify a temperature of the tunable band pass filter, which may adjust the material refractive index. The thermal heating element may comprise at least one resistor or diode. In some examples, the thermal heating element may include a thermoelectric cooler (TEC), resistive foil/ceramic heaters, thermistor/resistive heaters, indium tin oxide (ITO) coatings, or optically clear/transparent heaters. A thermal heating element may allow for precise temperature control. In some examples, the thermal heating elements may modify the local temperature of the band pass filter to within 5 degrees, 3 degrees, 2 degrees, 1 degree, 0.5 degrees, 0.1 degrees, 0.05 degrees, or 0.01 degrees C.

The adjustment of the material refractive index by the thermal heating element may rely on a thermo-optic effect, by which the refractive index of the waveguide material varies as a function of temperature. The magnitude of the wavelength shift achievable by the thermal heating element may be a function of the waveguide material, a resonator geometry, and a temperature range over which the thermal heating element may operate.

The thermal heating element may be disposed in thermal proximity to the waveguide or resonator structure of the band pass filter 208 so as to deliver localized heat to the optical mode volume while limiting heat transfer to adjacent components. In some examples, the thermal heating element may comprise a resistive heater deposited on or above the waveguide cladding, separated from the waveguide core by a thermal isolation layer configured to allow efficient heat delivery to the waveguide while maintaining electrical isolation. In some examples, thermal isolation trenches, undercuts, or air gaps may be provided adjacent to the band pass filter 208 to confine heat and reduce the thermal time constant and power consumption of the thermal heating element. In some examples, the thermal heating element may be configured to consume less than 50 milliwatts, less than 20 milliwatts, less than 10 milliwatts, less than 5 milliwatts, or less than 1 milliwatt per nanometer of wavelength shift.

The wavelength modification element 228 may respond to a control signal 222. The control signal may be provided from a controller. The controller may comprise a dedicated microcontroller, a digital signal processor, a field-programmable gate array (FPGA), an application-specific integrated circuit (ASIC), or a control block integrated within an electrical-to-optical driver integrated circuit. In some examples, the electrical-to-optical driver integrated circuit may be co-packaged with the band pass filter 208. The controller may be disposed on the same substrate as the band pass filter 208, within the same housing as the bi-directional optical communication module, or at a location remote from the module and communicatively coupled to the module via an electrical interface. In some examples, the controller may be configured to receive one or more input signals representative of an operating condition of the module and to generate the control signal 222 as a function of the one or more input signals.

The one or more input signals received by the controller may include, by way of example and not limitation: a temperature signal from a temperature sensor (such as a thermistor, resistance temperature detector (RTD), or on-chip temperature-sensing diode) disposed in thermal proximity to the second optical transmitter 210 or to the band pass filter 208; an optical power signal from a monitor photodiode optically coupled to a tap of the waveguide at or near an output of the second optical transmitter 210 or at the drop port 218 or through port 216 of the band pass filter 208; a wavelength locker signal from a wavelength-discrimination element (such as an etalon or a pair of detuned filters with a known spectral response); a supply voltage or bias current signal from the second optical transmitter 210; or an external command signal from a host system.

The control signal 222 may affect a voltage source that may affect operation of the wavelength modification element. The control signal may affect operation of a thermal heating element that may function as a wavelength modification element. The control signal may result in the adjustment of the material refractive index. This may compensate for thermal drift in the second wavelength generated by the second optical transmitter. Dynamic adjustment of the material refractive index may shift a center wavelength of a pass-band of the tunable band pass filter. The tunable band pass filter may dynamically alter a spectral transfer function of the tunable band pass filter by shifting the center wavelength of the pass-band to maintain spectral alignment with the first wavelength (λ₁) and/or the second wavelength (λ₂).

In some examples, in which the wavelength modification element 228 may comprise a resistive thermal heating element, the control signal 222 may set or modulate a voltage applied across the resistive heating element or a current driven through the resistive heating element, such that the electrical power dissipated in the resistive heating element may be controlled according to P=V²/R or P=I²R, where R is the resistance of the resistive heating element. The dissipated power, in turn, may determine the temperature rise ΔT of the band pass filter 208. The temperature rise ΔT may produce the refractive index change as described elsewhere herein, which may produce the resonant wavelength shift Δλᵣₑₛ, thereby shifting the center wavelength of the pass-band of the band pass filter 208.

In some examples, the controller may generate the control signal 222 in an open-loop configuration, in which the control signal 222 may be set based on a predetermined calibration relating a commanded pass-band center wavelength to a corresponding electrical drive level for the wavelength modification element 228. The calibration may be stored in a non-volatile memory accessible to the controller and may be determined during factory test or during an initialization routine of the module.

In some examples, the controller may generate the control signal 222 in a closed-loop configuration, in which the controller receives a feedback signal representative of an alignment between the pass-band of the band pass filter 208 and the first wavelength (λ₁) or the second wavelength (λ₂), and adjusts the control signal 222 so as to drive an error between a target alignment and the feedback signal toward zero. The feedback signal may be generated, for example, by a monitor photodiode coupled to the drop port 218 or the through port 216, such that the monitor photodiode produces a photocurrent proportional to the optical power present at the monitored port. The controller adjusts the control signal 222 to maximize or minimize the photocurrent according to which port corresponds to the aligned pass-band.

Thermal drift in the second wavelength (λ₂) generated by the second optical transmitter 210 may arise from changes in ambient temperature, self-heating of the second optical transmitter 210, aging of the second optical transmitter 210, or other environmental or operational factors. For a semiconductor laser source such as a vertical-cavity surface-emitting laser (VCSEL), the emission wavelength typically drifts with junction temperature at a rate of approximately 0.06 to 0.1 nanometer per degree Celsius. Without compensation, such drift may cause the second wavelength (λ₂) to move out of spectral alignment with the pass-band of the band pass filter 208, resulting in increased insertion loss, reduced spectral crosstalk isolation, or link failure. By adjusting the control signal 222 to modify the material refractive index of the band pass filter 208, the controller may shift the pass-band center wavelength to track the drifted second wavelength (λ₂) and maintain spectral alignment. In some examples, the controller may additionally or alternatively adjust a second control signal provided to a wavelength modification element associated with the second optical transmitter 210 (such as the wavelength modification element 224 of FIG. 11A) so as to stabilize the second wavelength (λ₂) itself.

In some examples, the controller may be configured to shift the pass-band center wavelength of the band pass filter 208 over a tuning range of at least 0.5 nanometer, at least 1 nanometer, at least 2 nanometers, at least 5 nanometers, at least 10 nanometers, or at least 20 nanometers, so as to accommodate thermal drift of the second optical transmitter 210 across an operating temperature range of the module. In some examples, the operating temperature range may span from 0 degrees Celsius to 70 degrees Celsius, from minus 5 degrees Celsius to 85 degrees Celsius, or another range consistent with the intended deployment environment of the module.

In some examples, the controller may dynamically alter the spectral transfer function of the band pass filter 208 not only by shifting the center wavelength of the pass-band but also by adjusting a bandwidth, a roll-off characteristic, or an extinction ratio of the pass-band, where the band pass filter 208 may be implemented as a multi-stage or tunable-bandwidth filter (such as a cascaded ring resonator with independently tunable stages). The dynamic alteration of the spectral transfer function may be used to accommodate multi-wavelength laser sources (such as a mode-locked comb laser or a bank of lasers) that generate a set of discrete wavelength lines spanning a spectral band, such that the pass-band of the band pass filter 208 may be configured to encompass the entire spectral band corresponding to the first wavelength (λ₁) or the second wavelength (λ₂).

FIG. 11C illustrates an example of a control of the tunable band pass filter 208 of a second bi-directional optical communication module in accordance with one or more examples of the present disclosure. As described, a second optical transmitter 210 may provide an optical signal to the tunable band pass filter 208. The optical transmitter may be provided at a second wavelength (λ₂). As described, thermal drift or other effects may occur with the optical transmitter that may cause the second wavelength to shift or move out of spectral alignment with the tunable band pass filter 208.

One or more monitors 232 or sensors may be provided that may generate one or more feedback signals representative of an operating condition of the second optical transmitter 210, the tunable band pass filter 208, or the optical signal propagating therebetween, and may provide the one or more feedback signals 234 to a controller 230 for use in generating the control signal 222. A monitor may include a monitor photodiode, a temperature sensor (such as a thermistor, a resistance temperature detector (RTD), or an on-chip temperature-sensing diode), a wavelength locker comprising one or more wavelength-discrimination elements (such as an etalon or a pair of detuned reference filters), an optical tap coupled to the waveguide, a current sensor configured to sense a bias current of the second optical transmitter 210, a voltage sensor configured to sense a supply voltage of the second optical transmitter 210, or a combination of two or more of the foregoing. In some examples, a monitor may be provided on a second optical transmitter to sense one or more conditions of the second optical transmitter. A monitor may sense one or more characteristics of an optical signal from the second optical transmitter to the tunable band pass filter, such as a wavelength of the optical signal. The monitor may be located on, within, or adjacent to the second optical transmitter 210; on or adjacent to the tunable band pass filter 208; optically coupled to the drop port 218, the through port 216, the input port 214, or the add port 220 of the tunable band pass filter 208 by way of a waveguide tap configured to divert a fraction of the optical power at the monitored port to the monitor; on the substrate 206 supporting the second optical transmitter 210 and the tunable band pass filter 208; co-packaged with the second optical transmitter 210 and the tunable band pass filter 208 within a housing of the bi-directional optical communication module; or at a location within the module positioned to sense the condition of interest.

Data from the one or more monitors 232 may be provided to a controller 230. The data may be provided to the controller 230 as an analog signal (such as a voltage or current output of the monitor), as a digital signal converted from an analog monitor output by an analog-to-digital converter (ADC), or as a digital signal transmitted over a serial interface (such as I²C, SPI, or MDIO). The controller 230 may sample the data from the one or more monitors 232 at a sampling rate sufficient to track a rate of change of the operating condition being monitored, which may be, by way of example, a sampling rate of at least 1 Hz, at least 10 Hz, at least 100 Hz, at least 1 kHz, or at least 10 kHz. The controller 230 may process the data from the one or more monitors 232 according to a control algorithm stored in a memory accessible to the controller 230, the control algorithm configured to determine, based on the data, a target value for the control signal 222 that drives an error between the monitored operating condition and a target operating condition toward zero. The control algorithm may comprise a proportional-integral (PI) algorithm, a proportional-integral-derivative (PID) algorithm, a dither-based algorithm (in which the controller 230 applies a small perturbation to the control signal 222 and observes a corresponding change in the monitor data to determine a direction of adjustment), a model-predictive control (MPC) algorithm, a lookup-table-based algorithm, or a combination thereof. In some examples, the controller 230 may further receive configuration data (such as a target pass-band center wavelength, a target operating temperature, or a target output power) from a host system via an external command interface, and may incorporate the configuration data into the determination of the target value for the control signal 222.

The controller 230 may send one or more control signals 222 to a wavelength modification element 228 of the tunable band pass filter. The control signal may control the wavelength modification element, which may result in an adjustment of a material refractive index, as described elsewhere herein. In some examples, the wavelength modification element may be a thermal heating element, and the control signal may set or modulate an electrical drive level applied to the thermal heating element so as to control an amount of electrical power dissipated in the thermal heating element, the dissipated power producing a corresponding temperature change in the tunable band pass filter 208, the temperature change producing a corresponding change in the material refractive index of the tunable band pass filter 208 via the thermo-optic effect, and the change in the material refractive index producing a corresponding shift in the center wavelength of the pass-band of the tunable band pass filter 208. The electrical drive level may be expressed as a voltage applied across the thermal heating element, a current driven through the thermal heating element, a duty cycle of a pulse-width-modulated (PWM) waveform applied to the thermal heating element, or a digital command value transmitted to a driver circuit coupled to the thermal heating element. The driver circuit may be configured to convert the control signal 222 into the electrical drive level applied to the thermal heating element, and may be integrated within the controller 230, integrated within an electrical-to-optical driver integrated circuit co-packaged with the tunable band pass filter 208, or implemented as a discrete component. In some examples, the controller 230 may send a plurality of control signals 222 to a corresponding plurality of wavelength modification elements 228, where the tunable band pass filter 208 comprises a multi-stage filter (such as a cascaded ring resonator filter with independently tunable stages), so as to independently adjust respective stages of the tunable band pass filter 208 and thereby adjust not only the center wavelength of the pass-band but also a bandwidth, a roll-off characteristic, or an extinction ratio of the pass-band.

In operation, the controller 230 may continuously or periodically receive data from the one or more monitors 232, determine an alignment condition between the pass-band of the tunable band pass filter 208 and the second wavelength (λ₂), generate the control signal 222 based on the determined alignment condition, and send the control signal 222 to the wavelength modification element 228, such that the tunable band pass filter 208 may be dynamically maintained in spectral alignment with the second wavelength (λ₂) as the second wavelength (λ₂) drifts due to thermal, aging, or other operational effects. The controller 230 may perform an analogous control function with respect to the first wavelength (λ₁), either by way of the same control loop (where the monitor 232 senses an alignment condition with respect to the first wavelength (λ₁)) or by way of a separate control loop with a separate monitor and a separate control signal. In some examples, the controller 230 may be further configured to execute an initialization routine during start-up of the module, in which the controller 230 sweeps the control signal 222 across a range of values, records the corresponding monitor data at each value, identifies a value of the control signal 222 that corresponds to a target alignment condition, and uses the identified value as an initial operating point for the control signal 222 during subsequent operation of the module.

FIG. 11D illustrates an optical communication module, according to some examples. The optical communication module may include a substrate 206, a first optical transmitter 210 supported by the substrate and configured to generate a first optical signal having a first wavelength, and a first optical receiver 212 supported by the substrate and configured to receive a second optical signal having a second wavelength distinct from the first wavelength.

The optical communication module may further include a band pass filter 108 supported by the substrate and communicably coupled to the first optical transmitter, the first optical receiver, and an optical port. The band pass filter may be a tunable band pass filter that may include a wavelength modification element 128 configured to dynamically adjust a material refractive index of the tunable band pass filter in response to a control signal 222. The dynamic adjustment configures the tunable band pass filter to: pass the first optical signal from the first optical transmitter to the optical port; and direct the second optical signal from the optical port into the first optical receiver.

The control signal may be provided from a controller 230 which may receive data from one or more monitors 232, as described elsewhere herein. The control signal 222 may be provided by the controller 230. The controller 230 may be an electrical-to-optical driver integrated circuit (referenced by 230) that generates the control signal 222. The controller may be separate from the first optical transmitter 210, the first optical receiver 212, and/or band pass filter, or may be incorporated as part of the first optical transmitter 210, the first optical receiver 212, and/or band pass filter.

In some examples, the first optical communication module 102 comprises a housing 205 that at least partially encloses the substrate 206, the tunable band pass filter 208, the first optical transmitter 210, and the first optical receiver 212.

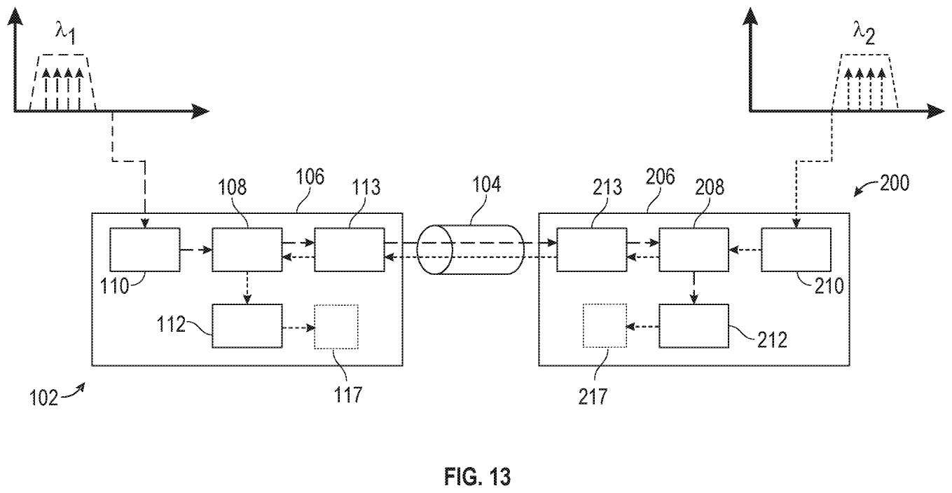

FIG. 13 illustrates an example bi-directional optical communication system in accordance with one or more examples of the present disclosure. A first optical communication module 102 may communicate with a second optical communication module 200. The optical communication may occur via at least one optical communication medium 104. The optical communication medium may be a flexible or bendable optical communication medium. The optical communication medium may include one or more optical fibers or optical cables. The optical communication medium may include thin, elongated, optically transmissive materials to transmit data as pulses of light. The optical communication medium may include at least one light-conducting core that may be surrounded by a cladding. The optical communication medium may have any length as selected based on an intended application of the bi-directional optical communication system, a distance between the first optical communication module 102 and the second optical communication module 200, an acceptable optical loss budget of the system, or a combination thereof. The light-conducting core may comprise silica, doped silica, a polymer optical fiber material, or another optically transmissive material suitable for propagation of optical signals at the first wavelength (λ₁) and the second wavelength (λ₂). In some examples, the optical communication medium 104 may comprise a single optical fiber configured to simultaneously carry optical signals at the first wavelength (λ₁) propagating in a first direction and optical signals at the second wavelength (λ₂) propagating in a second direction opposite to the first direction, such that bi-directional optical communication between the first optical communication module 102 and the second optical communication module 200 occurs over the single optical fiber. The bi-directional optical communication system of the present disclosure may employ wavelength division multiplexing (WDM) to carry optical signals at the first wavelength (λ₁) and optical signals at the second wavelength (λ₂) simultaneously over a single optical communication medium. In some examples, the first wavelength (λ₁) and the second wavelength (λ₂) correspond to distinct WDM channels on the single optical communication medium. In some examples, WDM may be implemented using coarse wavelength division multiplexing (CWDM) channel spacing (for example, approximately 20 nanometers between channels), dense wavelength division multiplexing (DWDM) channel spacing (for example, approximately 0.4 nanometer or approximately 0.8 nanometer between channels), or another WDM channel spacing consistent with the intended application of the bi-directional optical communication module.

A first optical communication module 102 may include a substrate 106, which may have any of the characteristics as described elsewhere herein. The first optical communication module may be attached to the at least one optical communication medium 104. The first optical communication module may be optically interfaced with the optical communication medium via one or more fiber input/output interfaces (fiber I/O 113). The fiber I/O 113 may comprise a fiber-to-chip coupling structure configured to couple optical signals between an end of the optical communication medium 104 and a waveguide disposed on or within the substrate 106. In some examples, the fiber I/O 113 may comprise a v-groove edge coupler fabricated into the substrate 106, in which a V-shaped groove may be formed in a surface of the substrate 106 to receive and align the end of the optical communication medium 104 with a waveguide end-facet at an edge of the substrate 106. In some examples, the fiber I/O 113 may comprise a grating-based vertical coupler fabricated into the substrate 106, in which a grating structure disposed on a surface of the substrate 106 redirects optical signals between the optical communication medium 104 (positioned above the substrate 106 at an angle) and a waveguide disposed within the substrate 106. In some examples, the fiber I/O 113 may comprise a spot-size converter, a lensed fiber coupler, a butt-coupling interface, or another fiber-to-chip coupling structure. In some examples, a single fiber I/O 113 may be provided on the first optical communication module 102, such that both transmitted optical signals generated by the first optical communication module 102 and received optical signals directed to the first optical communication module 102 pass through the same fiber I/O 113. A single fiber I/O 113 configuration may reduce a physical footprint of the fiber coupling on the substrate 106 and simplify the fiber routing between the first optical communication module 102 and the second optical communication module 200. In some examples, multiple fiber I/Os may be provided.

In some examples, a fiber I/O 113 may be referred to as an optical port of the first bi-directional optical communication module 102, the optical port comprising a structural interface on the substrate 106 through which optical signals enter and exit the first bi-directional optical communication module 102. The optical port may be implemented as the V-groove edge coupler, the grating-based vertical coupler, the spot-size converter, the lensed fiber coupler, the butt-coupling interface, or another fiber-to-chip coupling structure described above. In some examples, the band pass filter 108 may be communicably coupled to the first optical transmitter 110, the first optical receiver 112, and the optical port, such that the tunable band pass filter 108 routes optical signals between the first optical transmitter 110 and the optical port and between the first optical receiver 112 and the optical port.

In a configuration using the single fiber I/O 113, both the first optical transmitter 110 and the first optical receiver 112 may be optically coupled to the optical communication medium 104 through the same fiber I/O 113, with the band pass filter 108 disposed optically between the fiber I/O 113 and each of the first optical transmitter 110 and the first optical receiver 112. In this configuration, the band pass filter 108 may route outgoing optical signals at the first wavelength (λ₁) from the first optical transmitter 110 to the fiber I/O 113 and may route incoming optical signals at the second wavelength (λ₂) received through the fiber I/O 113 to the first optical receiver 112, such that a single fiber I/O 113 on the first substrate 106 serves both as an egress port for outgoing optical signals and as an ingress port for incoming optical signals. The band pass filter 108 may provide spectral isolation at the first optical transmitter 110, preventing optical signals at the second wavelength (λ₂) entering through the fiber I/O 113 from reaching the first optical transmitter 110 and preventing spectral interference at the output of the first optical transmitter 110.

In some examples, the substrate 106 of the first bi-directional optical communication module 102 comprises a photonic integrated circuit, and the first optical transmitter 110, the first optical receiver 112, and the tunable band pass filter 108 are monolithically integrated on the photonic integrated circuit. Monolithic integration may be accomplished, for example, by fabricating the first optical transmitter 110, the first optical receiver 112, and the tunable band pass filter 108 on a common photonic integrated circuit substrate using a compatible fabrication process, such as a silicon photonics fabrication process, or by heterogeneous integration in which one or more of the first optical transmitter 110 or the first optical receiver 112 are bonded to the photonic integrated circuit substrate through a flip-chip, micro-transfer printing, or wafer bonding process and communicably coupled to the tunable band pass filter 108 via a waveguide defined on the photonic integrated circuit substrate. Monolithic integration of the first optical transmitter 110, the first optical receiver 112, and the tunable band pass filter 108 on the photonic integrated circuit may reduce optical coupling losses between components, reduce the physical footprint of the first bi-directional optical communication module 102, and simplify manufacturing and assembly of the first bi-directional optical communication module 102.

The first optical communication module 102 may include a band pass filter 108 as described elsewhere herein. The band pass filter may or may not be a tunable band pass filter. In some examples, the band pass filter includes a wavelength modification element, as described elsewhere herein. In some examples, the band pass filter need not include a wavelength modification element. In examples in which the band pass filter 108 does not include a wavelength modification element, the spectral characteristics of the band pass filter 108 (including the center wavelength of the pass-band, the bandwidth of the pass-band, and the roll-off of the pass-band) may be fixed at the time of fabrication of the band pass filter 108. Such a fixed-wavelength band pass filter may be suitable for applications in which the first wavelength (λ₁) and the second wavelength (λ₂) are sufficiently stable that dynamic tuning is not required. In examples in which the band pass filter 108 includes a wavelength modification element, the spectral characteristics of the band pass filter 108 may be dynamically adjusted as described elsewhere herein to compensate for thermal drift, aging, or other variation of the first wavelength (λ₁) or the second wavelength (λ₂).

The first optical communication module may include a first optical transmitter 110. The first optical transmitter may have any characteristics as described elsewhere herein. The first optical transmitter may emit an optical signal with a first wavelength (λ₁). The first wavelength (λ₁) may be a single nominal wavelength emitted by a single-wavelength laser source, or may comprise a spectral band encompassing a plurality of discrete wavelength lines. In some examples, the first optical transmitter 110 may comprise a single-wavelength laser source, such as a distributed feedback (DFB) laser, a distributed Bragg reflector (DBR) laser, or a vertical-cavity surface-emitting laser (VCSEL), configured to emit an optical signal at the first wavelength (λ₁) with a spectral linewidth of less than 1 nanometer, less than 100 picometers, less than 10 picometers, less than 1 picometer, or less than 0.1 picometer. In some examples, the first optical transmitter 110 may comprise a multi-wavelength laser source configured to emit an optical signal occupying a first spectral band, the first spectral band comprising a plurality of discrete wavelength lines distributed across the first spectral band. The multi-wavelength laser source may comprise a mode-locked comb laser, a bank of lasers each configured to emit a respective one of the discrete wavelength lines, a Fabry-Pérot laser, a supercontinuum source, or a combination thereof. In some examples, the first spectral band may have a spectral width of at least 1 nanometer, at least 5 nanometers, at least 10 nanometers, or at least 20 nanometers, and may comprise at least 2, at least 4, at least 8, at least 16, or at least 32 discrete wavelength lines. The use of a multi-wavelength laser source may increase an aggregate data throughput of the first optical communication module 102 by enabling each of the discrete wavelength lines to carry an independent data stream.

In some examples, the first spectral band may be selected to be non-overlapping with a second spectral band corresponding to the second wavelength (λ₂) emitted by a second optical transmitter 210 of the second optical communication module 200, such that optical signals at the first spectral band and optical signals at the second spectral band may be distinguished by the band pass filter 108 and by a band pass filter 208 of the second optical communication module 200 without spectral crosstalk. In some examples, the first optical transmitter 110 and a second optical transmitter 210 of the second optical communication module 200 may be selected from two or more binning categories of a population of nominally identical laser sources, the two binning categories corresponding to the first spectral band and the second spectral band, respectively, such that manufacturing variability in the emission wavelength of the population of laser sources may be exploited to provide two distinct spectral bands for bi-directional optical communication.

In some examples, the binning categories may be defined by sorting the population of nominally identical laser sources according to a measured emission wavelength of each laser source, assigning laser sources with emission wavelengths falling within a first wavelength range to the first binning category corresponding to the first spectral band, and assigning laser sources with emission wavelengths falling within a second wavelength range to the second binning category corresponding to the second spectral band, the first wavelength range and the second wavelength range being non-overlapping. By sorting laser sources that would otherwise be considered nominally identical into two distinct binning categories, a manufacturing tolerance that conventionally limits wavelength uniformity across a population of laser sources may be used to provide the two distinct spectral bands used for bi-directional optical communication over the single optical communication medium 104, without requiring laser sources fabricated from different material systems or designed for different nominal emission wavelengths. In some examples, the slight variation in the emission wavelength across a population of nominally identical laser sources, which arises from manufacturing tolerances in epitaxial layer thicknesses, cavity geometries, or other fabrication parameters, may produce two distinct emission wavelength subpopulations within the population that may be sorted into the first binning category and the second binning category to provide the first spectral band and the second spectral band, respectively.

The optical signal of the first wavelength (λ₁) emitted from the first optical transmitter 110 may be directed to the band pass filter 108. The band pass filter 108 may be configured with a pass-band spectrally aligned with the first wavelength (λ₁) such that optical signals at the first wavelength (λ₁) propagate from an input port of the band pass filter 108 (communicably coupled to the first optical transmitter 110) to a through port of the band pass filter 108 (communicably coupled to the fiber I/O 113) with substantially low insertion loss. The band pass filter 108 may be configured to attenuate and redirect optical signals at a second wavelength (λ₂) distinct from the first wavelength (λ₁), such that optical signals at the second wavelength (λ₂) received from the fiber I/O 113 are redirected to an add port of the band pass filter 108 rather than passing to the input port of the band pass filter 108. In this manner, the band pass filter 108 provides spectral isolation between the optical signal generated by the first optical transmitter 110 at the first wavelength (λ₁) and optical signals received by the first optical communication module 102 at the second wavelength (λ₂), preventing spectral crosstalk at the first optical transmitter 110. This may allow the optical signal with the first wavelength (λ₁) to pass through the band pass filter to the fiber I/O 113 of the first optical communication module 102. The optical signal with the first wavelength (λ₁) may be transmitted over the optical communication medium 104.

After the optical signal has traversed the optical communication medium, it may be received at a second optical communication module 200. The second optical communication module 200 may include a fiber I/O 213 that may be optically interfaced with the optical communication medium 104. The fiber I/O 213 of the second optical communication module 200 may have any of the characteristics described with respect to the fiber I/O 113 of the first optical communication module 102, and may comprise a v-groove edge coupler, a grating-based vertical coupler, a spot-size converter, a lensed fiber coupler, a butt-coupling interface, or another fiber-to-chip coupling structure. In some examples, a single fiber I/O 213 may be provided on the second optical communication module 200, such that both transmitted optical signals generated by the second optical communication module 200 and received optical signals directed to the second optical communication module 200 pass through the same fiber I/O 213.

The optical signal with the first wavelength (λ₁) may be received via the fiber I/O 213 and provided to a band pass filter 208 of the second optical communication module. The band pass filter 208 may be configured with a pass-band spectrally aligned to redirect optical signals at the first wavelength (λ₁) from a through port of the band pass filter 208 (communicably coupled to the fiber I/O 213) to an add port of the band pass filter 208 (communicably coupled to the second optical receiver 212). The band pass filter 208 may be further configured to pass optical signals at the second wavelength (λ₂) generated by a second optical transmitter 210 of the second optical communication module 200 from an input port of the band pass filter 208 (communicably coupled to the second optical transmitter 210) to the through port of the band pass filter 208 for transmission into the optical communication medium 104 toward the first optical communication module 102. In this manner, the band pass filter 208 provides spectral routing of optical signals at the first wavelength (λ₁) toward the second optical receiver 212 while allowing optical signals at the second wavelength (λ₂) to be transmitted into the optical communication medium 104, thereby enabling bi-directional optical communication over the optical communication medium 104 using the same fiber I/O 213. This may allow the optical signal with first wavelength (λ₁) to be received by a second optical receiver 212.

The second optical receiver 212 may comprise a photodetector, such as a photodiode, an avalanche photodiode (APD), a positive-intrinsic-negative (PIN) photodiode, a germanium-on-silicon photodiode, or another photodetector configured to convert optical signals at the first wavelength (λ₁) into corresponding electrical signals. The second optical receiver 212 may be communicably coupled to a transimpedance amplifier (TIA) 217, a limiting amplifier, a clock and data recovery (CDR) circuit, or other receiver electronics configured to process the electrical signals generated by the second optical receiver 212 and to recover data encoded in the optical signals at the first wavelength (λ₁). In examples in which the first wavelength (λ₁) comprises a spectral band encompassing a plurality of discrete wavelength lines, the second optical receiver 212 may comprise a plurality of photodetectors, each photodetector configured to receive a respective one of the discrete wavelength lines, and the second optical communication module 200 may further comprise a wavelength demultiplexer disposed optically between the add port of the band pass filter 208 and the plurality of photodetectors, the wavelength demultiplexer configured to separate the plurality of discrete wavelength lines and to direct each discrete wavelength line to a respective one of the plurality of photodetectors. The recovered data may be output from the second optical communication module 200 to a host system (such as a switch, a processor, or a graphics processing unit) via an electrical interface of the second optical communication module 200.

Concurrently with, and independently of, the transmission of the optical signal at the first wavelength (λ₁) from the first optical communication module 102 to the second optical communication module 200, the second optical transmitter 210 of the second optical communication module 200 may emit an optical signal at the second wavelength (λ₂). The optical signal at the second wavelength (λ₂) may be directed to the band pass filter 208, which may be configured with a pass-band spectrally aligned with the second wavelength (λ₂) such that optical signals at the second wavelength (λ₂) propagate from an input port of the band pass filter 208 (communicably coupled to the second optical transmitter 210) to the through port of the band pass filter 208 (communicably coupled to the fiber I/O 213) with substantially low insertion loss. The optical signal at the second wavelength (λ₂) may be transmitted over the optical communication medium 104 toward the first optical communication module 102.

The optical signal at the second wavelength (λ₂) may be received at the first optical communication module 102 via the fiber I/O 113 and provided to the band pass filter 108. The band pass filter 108 may be configured to redirect optical signals at the second wavelength (λ₂) from the through port of the band pass filter 108 (communicably coupled to the fiber I/O 113) to an add port of the band pass filter 108 (communicably coupled to a first optical receiver 112). The first optical receiver 112 may comprise a photodetector having any of the characteristics described with respect to the second optical receiver 212. The first optical receiver 112 may convert the optical signal at the second wavelength (λ₂) into a corresponding electrical signal, which may be processed by receiver electronics of the first optical communication module 102 to recover data encoded in the optical signal at the second wavelength (λ₂). The recovered data may be output from the first optical communication module 102 to a host system via an electrical interface of the first optical communication module 102.

Any part of the second optical communication module 200, such as the substrate 206, fiber I/O 213, band pass filter 208, second optical transmitter 210, and/or second optical receiver, may have the same or similar characteristics to a corresponding part of first optical communication module 102, such as a corresponding substrate 106, fiber I/O 113, band pass filter 108, first optical transmitter 110, and/or first optical receiver.

The optical signal at the first wavelength (λ₁) and the optical signal at the second wavelength (λ₂) may occupy non-overlapping spectral bands and may be routed independently by the band pass filter 108 and the band pass filter 208, which may allow the two optical signals to propagate simultaneously over the optical communication medium 104 in opposite directions without spectral crosstalk or interference. This simultaneous bi-directional propagation over a single optical communication medium 104 may reduce a count of optical communication media required to establish a bi-directional optical link between the first optical communication module 102 and the second optical communication module 200 by a factor of two relative to a conventional duplex-fiber architecture in which a separate transmit fiber and a separate receive fiber are required at each of the first and second optical communication modules. The reduction in fiber count reduces a physical footprint, a weight, and a cost of the bi-directional optical communication system, and simplifies fiber routing in high-density deployment environments such as data centers and high-performance computing clusters.

The reduction in fiber count achieved by the bi-directional optical communication system may be understood with reference to a conventional duplex-fiber architecture. In the conventional duplex-fiber architecture, each of two communicating nodes comprises a transmitter coupled to a dedicated transmit fiber input/output interface and a receiver coupled to a separate, dedicated receive fiber input/output interface. A first dedicated optical fiber extends from the transmit fiber input/output interface of a first node to the receive fiber input/output interface of a second node, and a second dedicated optical fiber extends from the transmit fiber input/output interface of the second node to the receive fiber input/output interface of the first node, such that the first dedicated optical fiber carries only optical signals propagating in a first direction and the second dedicated optical fiber carries only optical signals propagating in a second direction opposite to the first direction. In a duplex-fiber architecture, optical signals propagating on the first dedicated optical fiber and optical signals propagating on the second dedicated optical fiber may occupy a common spectral band, because the dedicated optical fibers are not required to carry signals in both directions simultaneously. By contrast, the bi-directional optical communication system of the present disclosure uses the band pass filter 108 and the band pass filter 208 to spectrally separate optical signals propagating in opposite directions over the single optical communication medium 104, such that a single optical fiber and a single fiber input/output interface at each of the first optical communication module 102 and the second optical communication module 200 carry optical signals propagating in both directions simultaneously. The bi-directional optical communication system thereby reduces the number of optical fibers and the number of fiber input/output interfaces by a factor of two relative to the conventional duplex-fiber architecture, while carrying an equivalent aggregate bi-directional data throughput. A duplex-fiber architecture described above may also be referred to as a unidirectional optical link architecture, because each dedicated optical fiber in the duplex-fiber architecture carries optical signals propagating in only one direction. Accordingly, in some examples, the bi-directional optical communication module 102 reduces a fiber count by at least a factor of two compared to a unidirectional optical link architecture carrying an equivalent aggregate data between the first computing system 150 and the second computing system 250.

In some examples, the first optical communication module 102 and the second optical communication module 200 may be co-packaged with, or communicably coupled to, respective host processors, graphics processing units (GPUs), switch integrated circuits, or other electronic devices. In some examples, the first optical communication module 102 may be communicably coupled to a first GPU mounted on a first main circuit board, and the second optical communication module 200 may be communicably coupled to a second GPU mounted on a second main circuit board, such that the first GPU and the second GPU exchange data over the optical communication medium 104 via the first optical communication module 102 and the second optical communication module 200. In some examples, the electrical interface between each optical communication module and its respective host device may operate according to a high-bandwidth interconnect protocol, such as NVLink, PCI Express (PCIe), Compute Express Link (CXL), Ethernet, InfiniBand, or another interconnect protocol. In some examples, the host processor, the GPU, the switch integrated circuit, or another electronic device communicably coupled to the first optical communication module 102 or the second optical communication module 200 may be a hardware accelerator. As used herein, a hardware accelerator may comprise a graphics processing unit (GPU), a tensor processing unit (TPU), a neural processing unit (NPU), a data processing unit (DPU), an artificial intelligence (AI) accelerator, a machine learning accelerator, a deep learning accelerator, a field-programmable gate array (FPGA) configured to perform an accelerated computation, an application-specific integrated circuit (ASIC) configured to perform an accelerated computation, a vision processing unit (VPU), a cryptographic accelerator, a digital signal processor (DSP), or a combination of two or more of the foregoing. The hardware accelerator may be configured to perform one or more compute-intensive workloads, including, by way of example and not limitation, machine learning model training, machine learning model inference, graphics rendering, scientific simulation, data analytics, or cryptographic processing. Any description herein of a GPU may apply to any type of hardware accelerator, or vice versa.

In some examples, the first bi-directional optical communication module 102 may be mounted on the first main circuit board along with the first GPU, such that the first bi-directional optical communication module 102 and the first GPU are co-located on the first main circuit board and communicably coupled to one another via electrical traces defined on the first main circuit board. In some examples, the first bi-directional optical communication module 102 may be mounted on the first main circuit board as a pluggable transceiver received in a module receptacle disposed on the first main circuit board. In some examples, the first bi-directional optical communication module 102 may be soldered, bonded, or otherwise attached to the first main circuit board as a non-pluggable component. In some examples, the first bi-directional optical communication module 102 may be co-packaged with the first GPU within a common package disposed on the first main circuit board.

In some examples, the first GPU and the first bi-directional optical communication module 102 may be communicably coupled via an NVLink electrical interface, and the first bi-directional optical communication module 102 may be configured to convert NVLink electrical signals received from the first GPU into optical signals at the first wavelength (λ₁) for transmission over the optical communication medium 104, and to convert received optical signals at the second wavelength (λ₂) from the optical communication medium 104 into NVLink electrical signals for delivery to the first GPU. In some examples, the NVLink electrical interface may comprise a plurality of differential signaling lanes operating at a per-lane data rate of at least 25 gigabits per second, at least 50 gigabits per second, at least 100 gigabits per second, at least 200 gigabits per second, or at least 400 gigabits per second, in accordance with an NVLink specification. In some examples, the NVLink electrical interface may be implemented using NVLink-Common (NVLink-C), NVLink-Chip-to-Chip (NVLink-C2C), or another NVLink variant. In other examples, the first GPU and the first bi-directional optical communication module 102 may be communicably coupled via a PCI Express (PCIe) electrical interface, a Compute Express Link (CXL) electrical interface, an Ethernet electrical interface, an InfiniBand electrical interface, or another high-bandwidth interconnect electrical interface, and the first bi-directional optical communication module 102 may be configured to convert electrical signals of that interface into optical signals and vice versa.

The first optical communication module 102 or the second optical communication module 200 may be communicably coupled to, or co-packaged with, a switch integrated circuit of an NVLink switch, an NVSwitch device, or another high-bandwidth switch fabric component, such that the bi-directional optical communication link extends from a GPU, a processor, or another compute device through the switch integrated circuit and over the optical communication medium 104 to a remote compute device, a remote switch integrated circuit, or a remote GPU. In some examples, a plurality of bi-directional optical communication modules may be coupled to a single switch integrated circuit, such that the single switch integrated circuit supports a plurality of bi-directional optical communication links to a plurality of remote compute devices or remote switch integrated circuits, each bi-directional optical communication link operating over a respective single optical communication medium.

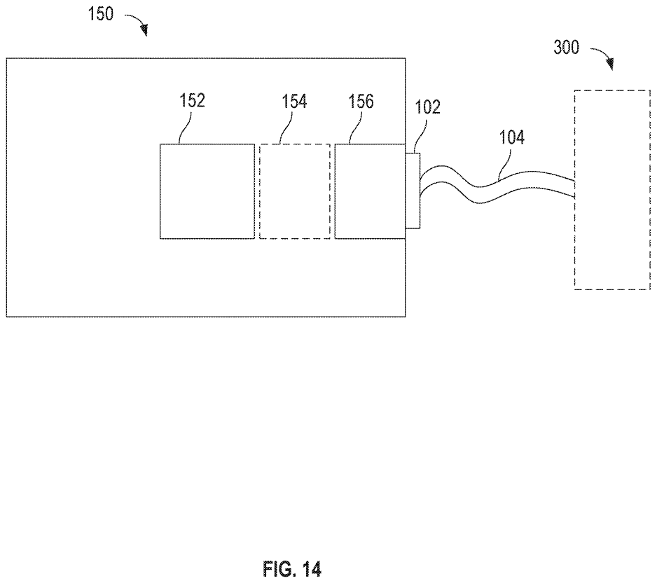

FIG. 14 shows an example of a computing system 150 with a processing unit 152 and an optical interface 156 in accordance with one or more examples of the present disclosure. A computing system may include one or more processing units 152. The processing units may include one or more CPUs, GPUs, QPUs, data processing units (DPUs), tensor processing units (TPUs), neural processing units (NPUs), field-programmable gate arrays (FPGAs), application-specific integrated circuits (ASICs), system-on-chip (SoC) devices, switch integrated circuits, network interface controllers, memory controllers, or a combination of any of the foregoing. The processing units may be any device configured to receive data transmitted via an optical transmission system. The one or more processing units 152 may be further configured to provide data which may be transmitted via the optical transmission system. In some examples, the computing system 150 may comprise a server, a switch, a router, a network interface card, a graphics processing card, an accelerator card, a storage node, a compute node of a high-performance computing cluster, a compute node of a data center, a blade of a blade server chassis, or another computing device configured to send and receive data over an optical communication link.

The computing system may include a chassis, such as a server tray, blade, or any other configuration. The computing system may include one or more substrates. In some examples, the substrate may be a PCB that may support one or more processing units. The PCB may comprise a main circuit board, a motherboard, a daughtercard, an interposer, a package substrate, or a combination thereof. The one or more processing units 152 may be mounted on, or integrated within, the substrate. In some examples, the substrate may support additional components of the computing system 150, including memory devices, voltage regulators, clock sources, management controllers, or other supporting circuitry. The substrate may include electrical traces configured to communicably couple the one or more processing units 152 to the optical interface 156, the electrical traces supporting high-speed serial signaling at data rates suitable for the optical transmission system (for example, at data rates of at least 25 gigabits per second per lane, at least 50 gigabits per second per lane, at least 100 gigabits per second per lane, or at least 200 gigabits per second per lane). In some examples, the computing system 150 may include a plurality of substrates communicably coupled to one another through a backplane, a midplane, or a cabled interconnect.

An optical transmission system may include an optical communication medium 104 and at least one optical communication module, such as a first optical communication module 102. The optical communication medium and first optical communication module may have any characteristics as described elsewhere herein.

The first optical communication module 102 may interface with the computing system 150 via an optical interface 156. In some examples, the optical interface 156 may include a receptacle into which the first optical communication module 102 may be plugged. The receptacle may comply with a multi-source agreement (MSA) form factor or an industry-standard pluggable transceiver form factor, including, by way of example and not limitation, a Small Form-factor Pluggable (SFP) form factor, an SFP+, SFP28, SFP56, or SFP112 form factor, a Quad Small Form-factor Pluggable (QSFP) form factor, a QSFP+, QSFP28, QSFP56, QSFP-DD, or QSFP112 form factor, an Octal Small Form-factor Pluggable (OSFP) form factor, a CFP, CFP2, CFP4, or CFP8 form factor, or an on-board optics (OBO) or co-packaged optics (CPO) form factor. The first optical communication module may conform to the form factor of the receptacle. The receptacle may include a mechanical latch or retention feature configured to secure the first optical communication module 102 in the receptacle, and may include an electrical connector configured to mate with a corresponding electrical connector of the first optical communication module 102 when the first optical communication module 102 may be plugged into the receptacle. The electrical connector may include a plurality of electrical contacts configured to carry high-speed data signals, low-speed management signals, and power between the first optical communication module 102 and the computing system 150. In other examples, the optical interface 156 may comprise a non-pluggable interface, such as a soldered-down optical engine, a co-packaged optical module mounted on the same substrate as the one or more processing units 152, or an optically coupled module bonded to the substrate via a flip-chip or other permanent attachment technique. In some examples, the module receptacle may be mounted on the main circuit board of the computing system 150, such that the first optical communication module 102 can be pluggably received in the module receptacle mounted on the main circuit board. In some examples, the module receptacle may be electrically coupled to the one or more processing units 152 through electrical traces on the main circuit board. In some examples, the module receptacle may be mounted on a faceplate, a front panel, a backplane, a midplane, or another support structure of the computing system 150, and may be electrically coupled to the one or more processing units 152 through a combination of electrical traces, cables, or connectors.

The optical interface 156 may communicate directly with one or more processing units 152. In some examples, an intermediary interface 154 may be provided between the optical interface and the one or more processing units. The intermediary interface 154 may comprise one or more of a retimer, a redriver, a signal conditioning circuit, a serializer/deserializer (SerDes), a protocol-aware switch, a network interface controller, a PCI Express (PCIe) switch, a Compute Express Link (CXL) switch, an NVLink switch, an NVSwitch, a bridge chip, a fabric controller, or a combination of two or more of the foregoing. The intermediary interface 154 may be configured to condition high-speed electrical signals passing between the optical interface 156 and the one or more processing units 152, to aggregate or distribute signals between a plurality of processing units 152 and the optical interface 156, to translate between signaling protocols used by the one or more processing units 152 and signaling protocols used by the optical interface 156, or a combination thereof. In some examples, the intermediary interface 154 may be mounted on the substrate of the computing system 150 along with the one or more processing units 152 and the optical interface 156. In some examples, the intermediary interface 154 may be integrated within a package containing the one or more processing units 152. In some examples, the optical interface 156 and the one or more processing units 152 may communicate according to a high-bandwidth interconnect protocol, including, by way of example and not limitation, NVLink, PCI Express (PCIe), Compute Express Link (CXL), Ethernet, InfiniBand, Common Electrical Interface (CEI), Open Compute Project (OCP) protocols, or a combination thereof.

Optical signals received at the first optical communication module 102 may have a second wavelength (λ₂). The receiver of the first optical communication module may convert the received optical signals at the second wavelength (λ₂) into corresponding electrical signals representative of data encoded in the received optical signals. The receiver may comprise a photodetector (such as a photodiode, an avalanche photodiode, a PIN photodiode, or a germanium-on-silicon photodiode) optically coupled to an add port of the band pass filter of the first optical communication module 102, and may further comprise receiver electronics (such as a transimpedance amplifier 117, a limiting amplifier, and a clock and data recovery circuit) configured to process the electrical signals generated by the photodetector. The optical interface 156 may couple the electrical signals generated by the receiver of the first optical communication module 102 to the computing system 150 via the electrical connector of the optical interface 156. This may cause the signals and data to be communicated to the one or more processing units 152. Similarly, the one or more processing units 152 may generate outgoing electrical signals representative of data to be transmitted over the optical communication system, and may route the outgoing electrical signals through the intermediary interface 154 (if present) and the optical interface 156 to the first optical communication module 102, where a driver circuit of the first optical communication module 102 modulates the optical transmitter according to the outgoing electrical signals. This may result in the generation of optical signals of a first wavelength (λ₁) via an optical transmitter of the first optical communication module 102 which may be communicated over an optical communication medium 104.

The computing system 150 and/or the first optical communication module 102 may be configured to communicate with a remote system 300. The first optical communication module 102 may be configured to establish a bi-directional optical link to a remote system 300 over an optical communication medium 104. In some examples, the remote system 300 may be a second computing system 250 as described elsewhere herein. The remote system may include any of the components or characteristics as provided for the second computing system, as described elsewhere herein.

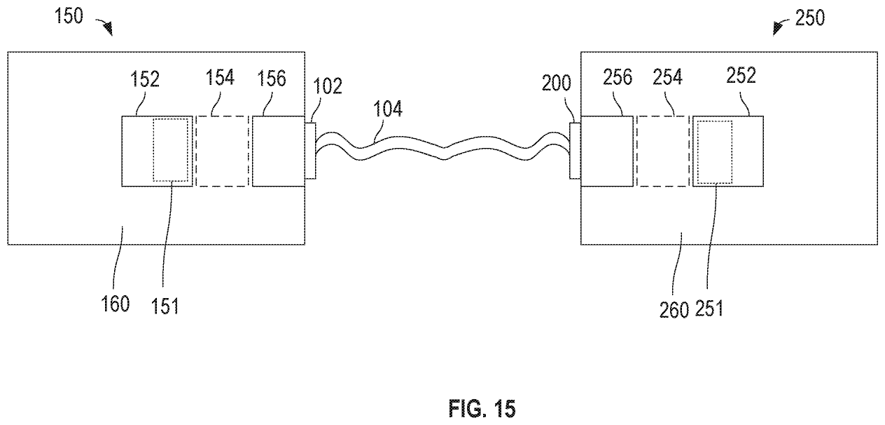

FIG. 15 shows an example of a system with computing systems communicating over a bi-directional optical communication system in accordance with one or more examples of the present disclosure.

A first computing system 150 may communicate with a second computing system 250 via one or more optical communication systems, including systems as illustrated in FIG. 13 and described elsewhere herein. The optical communication systems may include a first optical communication module 102 and a second optical communication module 200 that may be connected via an optical communication medium 104. The first optical communication module and the second optical communication module may have any characteristics or components as described elsewhere herein. The first optical communication module 102 may interface with the first computing system 150 and the second optical communication module 200 may interface with the second computing system 250.

The first computing system 150 and the second computing system 250 may each have any of the characteristics described with respect to the computing system 150 of FIG. 14, and may each comprise a server, a switch, a router, a network interface card, a graphics processing card, an accelerator card, a storage node, a compute node of a high-performance computing cluster, a compute node of a data center, a blade of a blade server chassis, or another computing device configured to send and receive data over an optical communication link. In some examples, the first computing system 150 and the second computing system 250 may be disposed in a common chassis, a common rack, a common row of racks, a common data center, or at geographically separated locations communicably coupled by the optical communication medium 104.

In some examples, the main circuit board 160 of the first computing system 150 may be disposed within a first server chassis, and the main circuit board 260 of the second computing system 250 may be disposed within a second server chassis distinct from the first server chassis. The optical communication medium 104, comprising the optical fiber communicably coupling the first optical communication module 102 and the second optical communication module 200, may extend from the first bi-directional optical communication module 102 disposed within the first server chassis to the second bi-directional optical communication module 200 disposed within the second server chassis. In some examples, the first server chassis and the second server chassis may be disposed in a common rack, a common row of racks, or a common data center. In some examples, the first server chassis and the second server chassis may be disposed at geographically separated locations. The server chassis may comprise a 1U, 2U, 4U, or other rack-mountable server chassis, a blade server chassis, a tower server chassis, or another enclosure suitable for housing server-class computing equipment.

As described elsewhere herein, the first optical communication module 102 may interface with a first optical interface 156 of a first computing system 150. The first computing system 150 may include one or more first processing units 152 communicably coupled to the first optical interface 156. In some examples, the one or more processing units may include one or more first hardware accelerators 151. The one or more first processing units 152 may be configured to generate first outgoing data for transmission over the optical communication medium 104 to the second computing system 250, and to receive first incoming data from the second computing system 250 via the optical communication medium 104. In some examples, a first intermediary interface 154 may be disposed between the first optical interface 156 and the one or more first processing units 152. The first intermediary interface 154 may be configured to condition high-speed electrical signals passing between the first optical interface 156 and the one or more first processing units 152, to aggregate or distribute signals between a plurality of first processing units 152 and the first optical interface 156, to translate between signaling protocols used by the one or more first processing units 152 and signaling protocols used by the first optical interface 156, or a combination thereof. In some examples, the first optical interface 156 may comprise a receptacle configured to receive the first optical communication module 102 as a pluggable transceiver, the receptacle complying with a multi-source agreement (MSA) form factor including, by way of example and not limitation, an SFP, QSFP, QSFP-DD, OSFP, CFP, or on-board optics form factor. In other examples, the first optical communication module 102 may be co-packaged with the one or more first processing units 152 as a co-packaged optics (CPO) module.

Similarly, the second optical communication module 200 may interface with a second optical interface 256 of a second computing system 250. The second computing system 250 may include one or more second processing units 252 communicably coupled to the second optical interface 256. In some examples, the one or more second processing units may include one or more second hardware accelerators 251. The one or more second processing units 252 may be configured to generate second outgoing data for transmission over the optical communication medium 104 to the first computing system 150, and to receive second incoming data from the first computing system 150 via the optical communication medium 104. In some examples, a second intermediary interface 254 may be disposed between the second optical interface 256 and the one or more second processing units 252. The second intermediary interface 254 may be configured to condition high-speed electrical signals passing between the second optical interface 256 and the one or more second processing units 252, to aggregate or distribute signals between a plurality of second processing units 252 and the second optical interface 256, to translate between signaling protocols used by the one or more second processing units 252 and signaling protocols used by the second optical interface 256, or a combination thereof. In some examples, the second optical interface 256 may comprise a receptacle configured to receive the second optical communication module 200 as a pluggable transceiver, the receptacle complying with any of the MSA form factors described above with respect to the first optical interface 156. In other examples, the second optical communication module 200 may be co-packaged with the one or more second processing units 252 as a co-packaged optics (CPO) module.

In operation, the one or more first processing units 152 of the first computing system 150 may generate first outgoing data and may transmit the first outgoing data, via the first intermediary interface 154 and the first optical interface 156, to the first optical communication module 102. A first optical transmitter of the first optical communication module 102 may modulate optical signals at a first wavelength (λ₁) according to the first outgoing data, and the modulated optical signals at the first wavelength (λ₁) may be routed by a first band pass filter of the first optical communication module 102 through a fiber input/output interface of the first optical communication module 102 into the optical communication medium 104. The modulated optical signals at the first wavelength (λ₁) may propagate through the optical communication medium 104 to the second optical communication module 200, where the modulated optical signals may be received through a fiber input/output interface of the second optical communication module 200 and routed by a second band pass filter of the second optical communication module 200 to a second optical receiver of the second optical communication module 200. The second optical receiver may convert the modulated optical signals at the first wavelength (λ₁) into corresponding electrical signals, which may be transmitted, via the second optical interface 256 and the second intermediary interface 254, to the one or more second processing units 252 of the second computing system 250, where the first outgoing data may be recovered.

Concurrently with, and independently of, the transmission of the first outgoing data at the first wavelength (λ₁) from the first computing system 150 to the second computing system 250, the one or more second processing units 252 of the second computing system 250 may generate second outgoing data and may transmit the second outgoing data, via the second intermediary interface 254 and the second optical interface 256, to the second optical communication module 200. Bi-directional optical interconnects may allow for simultaneous transmission and reception. A second optical transmitter of the second optical communication module 200 may modulate optical signals at a second wavelength (λ₂) distinct from the first wavelength (λ₁) according to the second outgoing data, and the modulated optical signals at the second wavelength (λ₂) may be routed by the second band pass filter through the fiber input/output interface of the second optical communication module 200 into the optical communication medium 104. The modulated optical signals at the second wavelength (λ₂) may propagate through the optical communication medium 104, in a direction opposite to the direction of propagation of the optical signals at the first wavelength (λ₁), to the first optical communication module 102, where the modulated optical signals may be received through the fiber input/output interface of the first optical communication module 102 and routed by the first band pass filter to a first optical receiver of the first optical communication module 102. The first optical receiver may convert the modulated optical signals at the second wavelength (λ₂) into corresponding electrical signals, which may be transmitted, via the first optical interface 156 and the first intermediary interface 154, to the one or more first processing units 152 of the first computing system 150, where the second outgoing data may be recovered.

Because the modulated optical signals at the first wavelength (λ₁) and the modulated optical signals at the second wavelength (λ₂) occupy non-overlapping spectral bands and are routed independently by the first band pass filter and the second band pass filter, the first outgoing data and the second outgoing data may be transmitted simultaneously over the single optical communication medium 104 in opposite directions without spectral crosstalk or interference. This simultaneous bi-directional data exchange over a single optical communication medium 104 reduces a count of optical communication media required to establish a bi-directional optical link between the first computing system 150 and the second computing system 250 by a factor of two relative to a conventional duplex-fiber architecture, in which a separate transmit fiber and a separate receive fiber are required at each of the first and second computing systems. The reduction in fiber count reduces a physical footprint, a weight, and a cost of the interconnect between the first computing system 150 and the second computing system 250, and simplifies fiber routing in high-density deployment environments such as data centers and high-performance computing clusters.

In some examples, the first computing system 150 and the second computing system 250 may be communicably coupled by a plurality of optical communication media 104 and a corresponding plurality of pairs of optical communication modules, such that the first computing system 150 and the second computing system 250 are interconnected by a plurality of bi-directional optical communication links. The plurality of bi-directional optical communication links may collectively form a portion of an optical interconnect fabric of a data center, a high-performance computing cluster, or another distributed computing environment. In some examples, the first computing system 150, the second computing system 250, and one or more additional computing systems may each comprise a compute node of a high-performance computing cluster, and the bi-directional optical communication links among the compute nodes may support inter-node data exchange for distributed workloads, including distributed training of machine learning models, distributed inference, distributed simulation, or distributed database operations.

In some examples, the optical interconnect fabric may comprise at least 16, at least 64, at least 256, at least 1,024, at least 4,096, or at least 16,384 bi-directional optical communication links, each bi-directional optical communication link comprising a single optical communication medium carrying optical signals at the first wavelength (λ₁) and optical signals at the second wavelength (λ₂) simultaneously in opposite directions. In an optical interconnect fabric deployed at such a scale, the reduction in fiber count by a factor of two relative to a conventional duplex-fiber architecture may reduce the total number of optical fibers routed in the physical infrastructure of a data center or high-performance computing cluster by thousands or tens of thousands of fibers, correspondingly reducing cable tray loading, cable management complexity, and overall interconnect deployment cost.

In some examples, a first optical communication module 102, or an optical interconnect module having the same components and configuration as the first optical communication module 102, may be configured to achieve a combined, simultaneous bi-directional data throughput over the optical communication medium 104 of at least 100 gigabits per second, at least 200 gigabits per second, at least 400 gigabits per second, at least 800 gigabits per second, at least 1.6 terabits per second, at least 3.2 terabits per second, or at least 6.4 terabits per second. The combined, simultaneous bi-directional data throughput may comprise a first portion corresponding to optical signals at the first wavelength (λ₁) propagating in a first direction over the optical communication medium 104 and a second portion corresponding to optical signals at the second wavelength (λ₂) propagating in a second direction over the optical communication medium 104. In some examples, the first portion and the second portion may each be at least half of the combined, simultaneous bi-directional data throughput, such that each of the first wavelength (λ₁) and the second wavelength (λ₂) carries a bidirectional data rate component of at least 50 gigabits per second, at least 100 gigabits per second, at least 200 gigabits per second, at least 400 gigabits per second, at least 800 gigabits per second, at least 1.6 terabits per second, or at least 3.2 terabits per second.

In some examples, the band pass filter 108 and the band pass filter 208 may be configured to provide a spectral crosstalk isolation between the transmitted optical signal and the received optical signal of greater than 15 dB, greater than 20 dB, greater than 25 dB, greater than 30 dB, greater than 35 dB, or greater than 40 dB. The spectral crosstalk isolation may be measured as a ratio of optical power at the first wavelength (λ₁) arriving at the through port of the band pass filter 108 to optical power at the first wavelength (λ₁) leaking to the add port of the band pass filter 108, or equivalently as a ratio of optical power at the second wavelength (λ₂) arriving at the add port of the band pass filter 108 to optical power at the second wavelength (λ₂) leaking to the through port of the band pass filter 108. A higher spectral crosstalk isolation may reduce interference between the transmitted optical signal and the received optical signal, thereby reducing a bit error rate of the bi-directional optical communication link and allowing the bi-directional optical communication link to operate at higher data rates and over longer distances.

In some examples, the band pass filter 108 may exhibit an insertion loss for the transmitted optical signal passing from the first optical transmitter 110 through the band pass filter 108 into the optical communication medium 104 of less than 5 dB, less than 3 dB, less than 2.5 dB, less than 2 dB, less than 1 dB, less than 0.5 dB, or less than 0.25 dB. The insertion loss may be measured as a ratio of optical power at the first wavelength (λ₁) at an output of the first optical transmitter 110 to optical power at the first wavelength (λ₁) at the through port of the band pass filter 108, or equivalently at the fiber I/O 113, with the ratio expressed in decibels.

In some examples, the band pass filter 108 may exhibit an insertion loss for the received optical signal passing from the optical communication medium 104 through the band pass filter 108 into the first optical receiver 112 of less than 5 dB, less than 3 dB, less than 2.5 dB, less than 2 dB, less than 1 dB, less than 0.5 dB, or less than 0.25 dB. The insertion loss may be measured as a ratio of optical power at the second wavelength (λ₂) at the through port of the band pass filter 108, or equivalently at the fiber I/O 113, to optical power at the second wavelength (λ₂) at the add port of the band pass filter 108 at an input of the first optical receiver 112, with the ratio expressed in decibels.

In some examples, the first bi-directional optical communication module 102 may have a total power consumption of less than 20 watts, less than 15 watts, less than 10 watts, less than 5 watts, less than 3 watts, or less than 1 watt while operating at the combined, simultaneous bi-directional data throughput described elsewhere herein. The total power consumption may include a sum of the power consumed by the first optical transmitter 110, the first optical receiver 112, the band pass filter 108, the wavelength modification element, the controller, the electrical-to-optical driver integrated circuit, the receiver electronics, and any other active components of the first bi-directional optical communication module 102. In some examples, the total power consumption of the first bi-directional optical communication module 102 may be normalized to the combined, simultaneous bi-directional data throughput to yield an energy-per-bit figure of merit of less than 50 picojoules per bit, less than 25 picojoules per bit, less than 10 picojoules per bit, less than 5 picojoules per bit, less than 3 picojoules per bit, or less than 1 picojoule per bit.

In some examples, the first bi-directional optical communication module 102 may be configured to maintain a bit error rate below 10⁻⁶, below 10⁻⁹, below 10⁻¹², below 10⁻¹⁵, or below 10⁻¹⁸ across an operating temperature range of the first bi-directional optical communication module 102. The operating temperature range may span from 0 degrees Celsius to 70 degrees Celsius, from minus 5 degrees Celsius to 85 degrees Celsius, from minus 40 degrees Celsius to 85 degrees Celsius, or another range consistent with the intended deployment environment of the first bi-directional optical communication module 102. The bit error rate may be measured as a ratio of a count of erroneously received bits to a total count of transmitted bits over a defined measurement interval, with the erroneously received bits identified through a forward error correction decoder, a bit error rate tester, or another bit error measurement methodology. The dynamic adjustment of the material refractive index of the band pass filter 108 by the wavelength modification element, as described elsewhere herein, may be used to maintain the bit error rate within the above-specified ranges across the operating temperature range by compensating for thermal drift of the first wavelength (λ₁) and the second wavelength (λ₂).

### Example Methods for Manufacturing

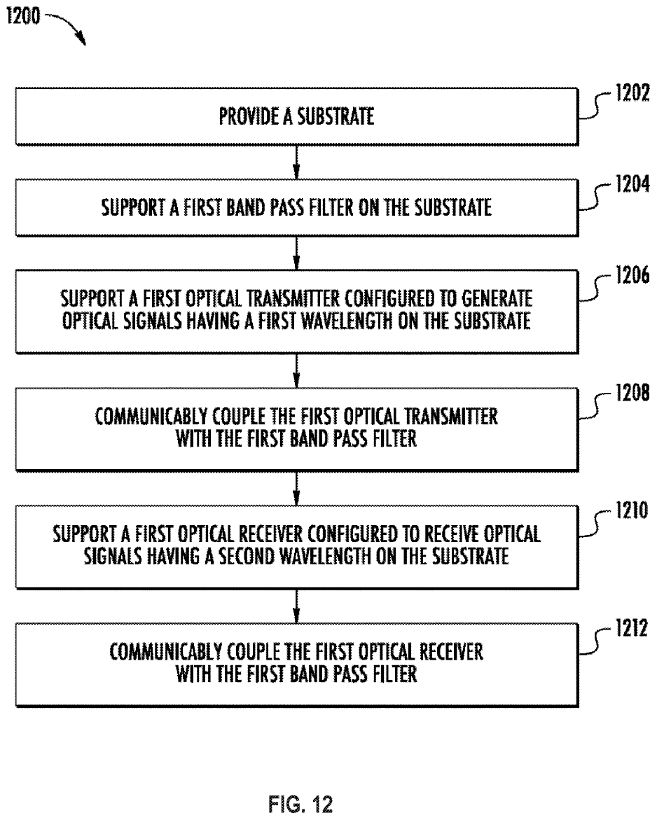

With reference to FIG. 12, an example method (e.g. method 1200) for scalable networking systems is illustrated. As shown in Block 1202, the method may include providing a substrate. As described above, the substrate may, for example, be a printed circuit board (PCB) or other equivalent support structure compatible with operation of opto-electronic components. As such, the substrate may define one or more electrical traces, wires, etc. configured to establish electrical communication between the opto-electronic components described herein. Although illustrated herein as a generally planar substrate, the present disclosure contemplates that the dimensions (e.g., size and/or shape) of the substrate may vary based on the intended application of the module and may, in some examples, refer to a plurality of substrates that are, for example, attached so as to collectively support the components described herein.

As shown in Block 1204, the method may include supporting a first band pass filter on the substrate. As described above, the first band pass filter may be configured to pass optical signals having the first wavelength (λ₁) into an optical communication medium and may direct optical signals received from the optical communication medium having the second wavelength (λ₂). To do so, the first band pass filter may include an input port, a through port, a drop port, and an add port. As would be evident to one of ordinary skill in the art in light of the present disclosure, the relative positioning between these ports may be defined once any port is determined. The first band pass filter may be associated with the second wavelength (λ₂) in that the first band pass filter is configured to attenuate optical signals having the second wavelength (λ₂). As would be evident to one of ordinary skill in the art in light of the present disclosure, the first band pass filter may be configured to pass through optical signals having any wavelength other than the second wavelength (λ₂) while the attenuation of the optical signals having the second wavelength (λ₂) results in re-direction of the optical signal to the adjacent ports as described above.

As shown in Blocks 1206 and 1208, the method may further include supporting a first optical transmitter configured to generate optical signals having a first wavelength on the substrate and communicably coupling the first optical transmitter with the first band pass filter. As described above, the first optical transmitter may be configured to generate optical signals having a first wavelength (λ₁) for transmission via the optical communication medium for receipt by a corresponding optical receiver communicably coupled with the optical communication medium. In some examples, the first optical transmitter may be a vertical-cavity surface-emitting laser (VCSEL) configured to generate optical signals having a first wavelength (λ₁).

As shown in Blocks 1210 and 1212, the method may further include supporting a first optical receiver configured to receive optical signals having a second wavelength on the substrate and communicably couple the first optical receiver with the first band pass filter. As described above, the first optical receiver may be supported by the substrate and configured to receive optical signals. As described herein, the first optical receiver may be configured to receive optical signals having a second wavelength (λ₂), such as those received from the optical communication medium that are generated by a corresponding optical transmitter communicably coupled with the optical communication medium. In some examples, the first optical receiver may be a photodiode configured to receive optical signals having a second wavelength (λ₂).

### Example Multi-Chip Module (MCM) Assembly

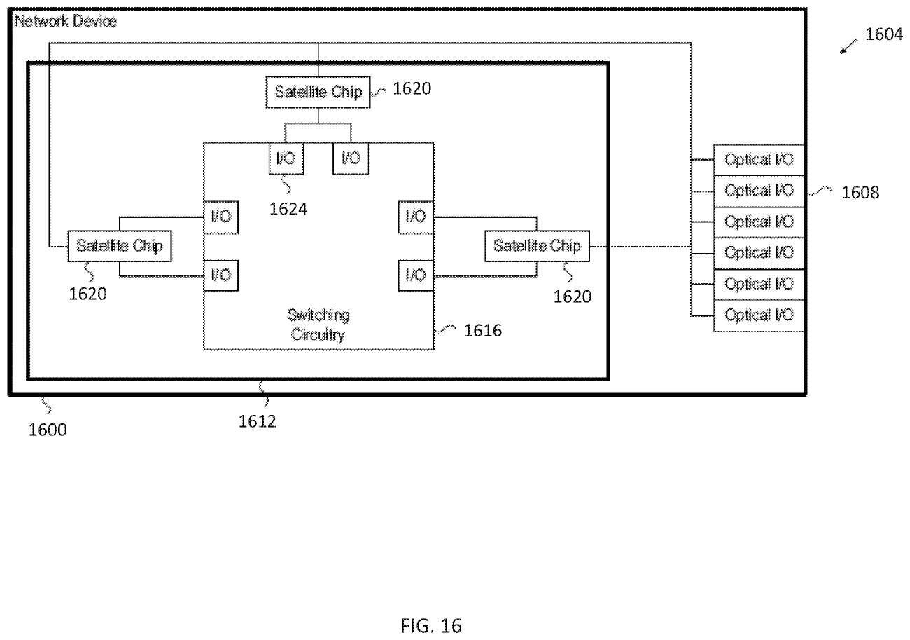

FIG. 16 is a block diagram that schematically illustrates a co-packaged networking device 1600, in accordance with an example that is disclosed herein. The different chips that constitute a co-packaged networking device are assembled on a single substrate in what is typically called the MCM assembly 1612. The MCM assembly 1612 can include a switching circuitry 1616 surrounded by peripheral or satellite chips 1620. In some examples, the switching circuitry 1616 and surrounding satellite chips 1620 are all mounted on a common substrate, although such a configuration is not required. The MCM assembly 1612 may be provided in a larger housing of the networking device 1600, positioned behind the front panel 1604. The switching circuitry 1616 may include one or more core digital Application Specific Integrated Circuits (ASICs), CPUs, GPUs, microprocessors, FPGAs, combinations thereof, and the like. The switching circuitry 1616 may include a number of input ports and/or output ports 1624. The Input/Output (I/O) ports 1624 may include electrical ports and/or optical ports. Additionally, the switching circuitry 1616 may include a combination of electrical blocks and optical blocks. The electrical blocks of the switching circuitry 1616 may include a number of electrical switches that are configured to route signals in an electrical domain. The optical blocks of the switching circuitry 1616 may include a number of optical components that are configured to generate, detect and route signals in an optical domain. The MCM assembly 1612, in some examples, may concern or include multiple satellite chips 1620 that are assembled on the same substrate as the switching circuitry 1616. In some examples, a configuration of the optical block(s) and a configuration of the electrical block(s) depends (e.g., is based on) on the number of optical ports in the I/O ports 1624.

As discussed above, optical I/Os 1608, which may also be referred to as optical connectors, are placed at the front panel 1604. As mentioned above, connectivity between the MCM assembly 1612 and optical I/Os 1608 may be transferred to the front panel 1604 through optical fibers. This connection may be made directly with an optical I/O 1624 of the switching circuitry or may be made with one or more of the satellite chips 1620. The connection is often made with one or more of the satellite chips 1620 because the satellite chips 1620 may include the electro-optic converters and, possibly, the SERDES to natively support the connection. The satellite chips 1620 may include one or more of a DSP processor, driver, trans-impedance amplifier, laser, modulator, photodiode, serializer-deserializer, or the like.

Some examples of the present disclosure are directed to a multi-chip module (MCM) with a centrally positioned main die and a plurality of peripherally positioned MCM sockets configured to mechanically receive and electrically connect mezzanine packages, which may include co-packaged optics (CPO) packages and co-packaged copper (CPC) packages. Each mezzanine package may include a package substrate including a connector portion that is configured to engage the MCM socket and a main portion extending beyond the periphery of the MCM substrate. The main portion of the mezzanine package may be configured to receive optical devices and/or integrated circuits, such as via mezzanine sockets, to allow connections to be made between the optical devices and/or integrated circuits/ RF copper cable connectors and the main die of the MCM. Due to the extension of the mezzanine package beyond the periphery of the MCM substrate, the physical size of the MCM substrate may remain small to reduce cost and avoid the previously discussed production challenges, while allowing connections to a number of optical devices and integrated circuits via the mezzanine packages, which occupy the relatively inexpensive space around the periphery of the MCM substrate. As used herein, the terms “co-packaged optic” (or “CPO”) and “co-packaged copper” (or “CPC”) may refer to an advanced heterogeneous integration of either optics and silicon or copper and silicon, in which either integration may be implemented on a single packaged substrate. The CPO may utilize pluggable optical modules that include an optical engine (OE) to convert optical signals to electrical signals and electrical signals to optical signals. The CPO may further be comprised of an optical component on a photonics die and an electrical component on an electrical die.

As used herein, a ball grid array (BGA) may be a type of surface-mount packaging used for integrated circuits. BGA packages use an array of metallic conductor balls arranged in a grid to permanently mount devices such as microprocessors on a PCB. The metallic conductor balls may then undergo the reflow process described above, wherein the metallic conductor balls may be preheated, then melted to bond the IC to a substrate to form an IC package.

As used herein, a flip chip (FC) may refer to a method for interconnecting dies, such as semiconductor devices, IC chips, integrated passive devices, and microelectromechanical systems (MEMS), to external circuitry with solder bumps that have been deposited onto chip pads. The solder bumps may be deposited onto chip pads on the top side of the wafer during final wafer processing. The chip may be mounted to external circuitry (such as a circuit board or another chip or wafer) by “flipping” the chip, such that the chip's top side faces down and is positioned to allow the pads of the chip to align with matching pads on the external circuit. Solder is reflowed to complete the interconnect.

An integrated photonics device as used herein refers to a device comprising a plurality of photonic components fabricated and co-located on a common substrate to guide, manipulate, generate, or detect optical signals. Integrated photonics devices are designed to perform high-speed, low-latency signal processing or communication tasks with reduced power consumption and improved signal integrity, often serving applications in data communications, telecommunications, sensing, quantum technologies, or biomedical systems.

The device typically includes waveguides, modulators, couplers, filters, detectors, and one or more integrated light sources, such as lasers, forming a compact, monolithically or heterogeneously integrated photonic circuit. The substrate may be formed from materials suitable for photonic integration, including but not limited to silicon, silicon nitride, indium phosphide, or other compound semiconductors. In some examples, the integrated laser is formed on the same substrate (monolithic integration), while in other examples, the laser is fabricated separately and bonded or coupled to the photonic circuit (hybrid or heterogeneous integration). The integrated laser may be a distributed feedback (DFB) laser, distributed Bragg reflector (DBR) laser, external cavity laser, or other suitable type depending on the target application.

The integrated laser provides an on-chip optical source, enabling self-contained optical transmission, modulation, and routing without reliance on external light sources. This allows for reduced system complexity, lower coupling loss, and improved scalability in densely packed photonic systems.

An integrated photonics device may further include electrical drivers and control circuitry co-packaged with the photonic components, forming a photonic-electronic integrated system. The design supports high-speed, low-power optical communication and signal processing across a range of applications, including data center interconnects, high-performance computing, telecommunications, optical sensing, and integrated LiDAR systems.

Packaging and coupling interfaces may be provided to facilitate optical I/O to and from the chip, such as edge couplers, grating couplers, or fiber array terminations. Thermal management structures may also be included to maintain performance stability of the integrated laser and surrounding photonic components. In certain examples, the photonic device may interface with electrical components, either on the same chip or through an adjacent electronic integrated circuit (EIC), to form a photonic-electronic co-integrated system. Packaging considerations may include fiber coupling interfaces, thermal management structures, and alignment features to ensure stable operation.

### Packaging

Packaging techniques for integrated circuit chips have developed such that modern central processing unit (“CPU”) and graphics processing unit (“GPU”) packages include a substrate on which the integrated circuit die is mounted. A rectangular grid or array of connecting points is typically provided on the bottom side of the substrate to connect the circuitry of the integrated circuit die with the circuitry of a host system printed circuit board (“PCB”) through conductors inside the substrate. Examples of such grids or arrays of connecting points include pin grid arrays (“PGA”), ball grid arrays (“BGA”), land grid arrays (“LGA”), and the like. A substrate has a larger area than does an integrated circuit die, so inclusion of a substrate in the chip package makes more space available to accommodate the relatively large PGA pins, BGA solder balls, or LGA contact pads that must be placed on the package.

In the packaging of integrated circuit (IC) chips, various packaging schemes are employed, including traditional two-dimensional (2D) integrated circuit (IC) packages as well as the more recently introduced 2.5D IC and 3D IC packages. In 2D IC packages, multiple chips are mounted on a printed circuit board, where high-performance logic, lower-performance logic, memory, and analog/RF functions, and other functional elements are presented as discrete devices in separate chip packages. By contrast, in 2.5D ICs and 3D IC packages, multiple IC chips are mounted on a silicon interposer instead of a conventional package substrate. The silicon interposer, which is typically a silicon wafer, allows very small and high-density conductive traces to be formed between the multiple IC chips because the fabrication processes used to form the conductive traces are the same processes used to form the metal interconnects in the metallization layers of a silicon chip.

Compared to 2.5D IC packages and 3D IC packages, a circuit board with individually packaged chips, such as a 2D IC package, has numerous disadvantages. For example, a 2D IC package is generally larger, heavier, consumes more power, and, because the signals propagate relatively slowly across the circuit board from one chip to another, is slower than an equivalent 2.5D or 3D IC package. Furthermore, a 2D IC package has more possible points of failure, given that the soldered joints on the circuit board are more likely to fail than the electrical connections formed within an interposer. That said, troubleshooting a 2D IC package after the different chips have been mounted on the circuit board is relatively straightforward. In particular, the conductive traces carrying I/O signals between the various chips on the circuit board are easily accessible and therefore can be employed to measure specific I/O signals during troubleshooting.

By contrast, troubleshooting a 2.5D or 3D IC package is far more problematic because the I/O signals transmitted between the different chips typically are embedded in the silicon interposer and are not physically accessible. Furthermore, because 2.5D and 3D IC packages are high-bandwidth and are quite dense, typically implementations can include thousands of conductive traces routed between the different chips. One example of such an implementation is a memory bus residing in between a processor and a high-bandwidth memory chip.

In such implementations, even if the traces could be physically accessed through the silicon interposer with a probe, the accurate and reliable selection of a specific conductive trace or combination of conductive traces for the purpose of troubleshooting the IC package would be very difficult, if not impossible.

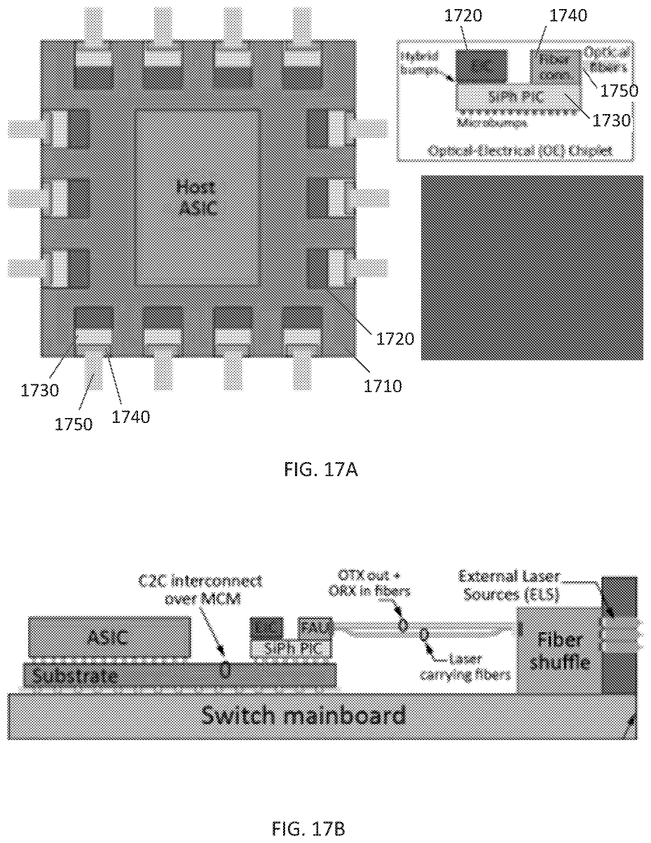

An example of a 2.5D IC package is shown in FIG. 17A and FIG. 17B.

FIG. 17A is a top view of a 2.5D integrated co-packaged optics with the host ASIC on an organic substrate, according to some examples. An organic MCM substrate 1710 may be provided. On the substrate, one or more SiPh PICs 1730 may be provided. The SiPh PICs may be arranged in groups around the substrate. In some examples, a host ASIC may be provided at a central region of the substrate. The SiPh PICs 1730 may support a complementary metal-oxide semiconductor (CMOS) electronic integrated circuit (EIC) 1720. The SiPh PIC 1730 may also support a fiber connector 1740 providing connection to one or more optical fibers 1750.

FIG. 17B is a cross-sectional view of the 2.5D integrated co-packaged optics with the host ASIC on the organic substrate, according to some examples. An external laser source (ELS) may optically communicate with a CPO one or more optical fibers. The optical fibers may form an FAU, which may be coupled to the SiPh PIC. The SiPh PIC may support an EIC. A substrate may support one or more SiPh PICs and/or a host ASIC. The substrate may be supported on a switch mainboard, which may also support the ELS.

### Example With External Laser Source

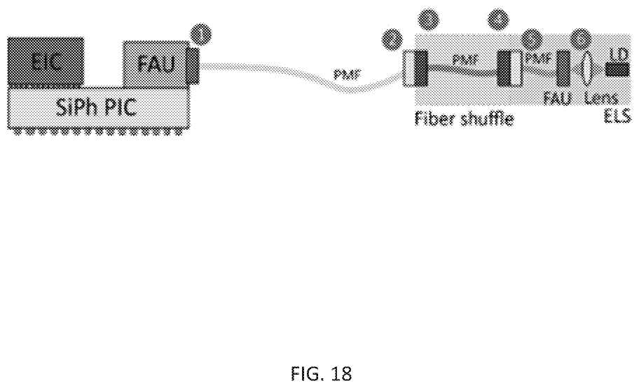

FIG. 18 illustrates an optical path from an external laser source (ELS) to an input for a co-packaged optics (CPO) system, according to some examples. An external laser source in a CPO system refers to a laser device physically separate from, but optically coupled to, the co-packaged optical module or photonic integrated circuit (PIC) within a high-speed data transmission assembly. This external placement allows the laser source to be optimized independently for performance, thermal management, and reliability, while maintaining a compact and efficient overall optical link.

The external laser source typically provides continuous-wave (CW) laser light at designated wavelengths, which is coupled into the optical module through fiber, waveguides, grating couplers, or edge couplers. By separating the laser source from the CPO module, challenges related to heat dissipation, laser tuning, and replacement are mitigated, improving system maintainability and scalability.

In CPO architectures, the external laser source is integrated into the optical link to deliver stable, coherent light to modulators or other photonic components co-located with the electronic device or processor. This arrangement supports ultra-high bandwidth density, low latency, and reduced power consumption, making it suitable for applications in data centers, telecommunications, high-performance computing, and artificial intelligence accelerators.

As illustrated in (1), an actively aligned polarization-maintaining fiber (PMF) in FAU V-grooves may be provided for CPO. As illustrated in (2), a mechanical transfer (MT) connector connecting to a backplane adapter may be provided. In (3), a high-density fiber shuffle connector may be provided. As illustrated in (4), a high-density fiber shuffle connector may be provided. In (5) an MT connector may be provided at an output of an ELS module. Furthermore, (6) illustrates an actively aligned PMF in FAU V-grooves for ELS.

### Example System Use-Case

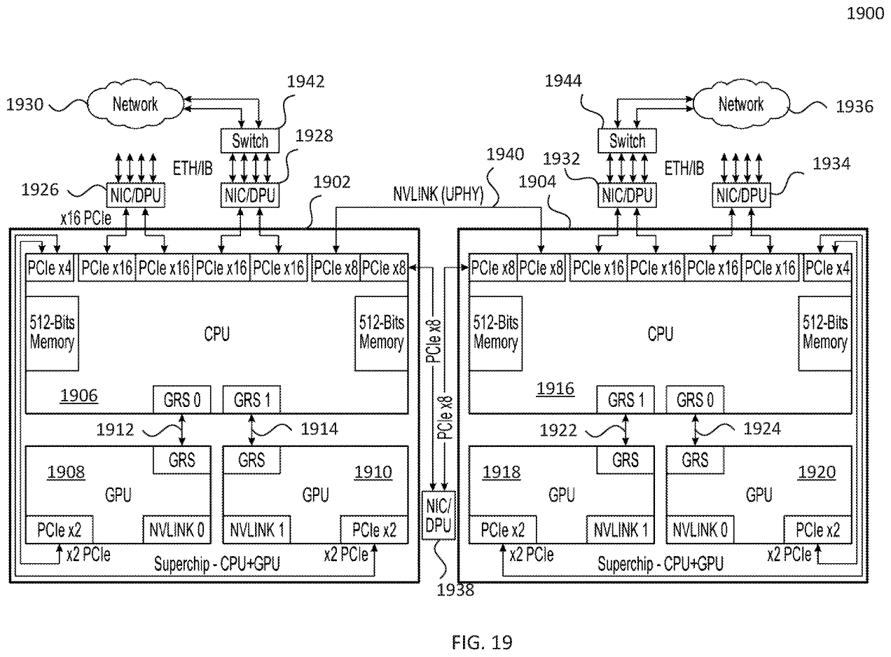

FIG. 19 is a block diagram that schematically illustrates a computing system 1900, e.g., a datacenter or a High-Performance Computing (HPC) cluster, in accordance with some examples that are described herein. Computing system 1900 comprises a plurality of subsystems, e.g. multiple processing devices coupled to each other, multiple network devices, and multiple networks, according to at least one example. Computing system 1900 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1900 and to one or more external networks 1930, 1936. In the present example, computing system 1900 comprises a packet switch 1942 that connects NIC/DPU 1928 to network 1930, and a packet switch 1944 that connects NIC/DPU 1932 to network 1936.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1900 can include one or more CPUs and one or more GPUs.

FIG. 19 also demonstrates an example architecture of a multi-GPU architecture. As illustrated in the figure, computing system 1900 includes a processing device 1902 with a multi-GPU architecture. In particular, processing device 1902 may be a system-on-chip and includes multiple subsystems such as a CPU 1906, a GPU 1908, and a GPU 1910. CPU 1906 can be coupled to GPU 1908 via a die-to-die (D2D) or chip-to-chip (C2C) interconnect 1912, such as a Ground-Referenced Signaling interconnect (GRS interconnect). CPU 1906 can be coupled to GPU 1910 via a D2D or C2C interconnect 1914. CPU 1906 can also couple to GPU 1908 and GPU 1910 via PCIe interconnects.

CPU 1906 can be coupled to one or more NICs or DPUs, which are coupled to one or more networks. For example, as illustrated in FIG. 19, CPU 1906 is coupled to a first NIC/DPU 1926, which is coupled to a network 1930. CPU 1906 is also coupled to a second NIC/DPU 1928, which is coupled to network 1930 via switch 1942. NIC/DPU 1926 and NIC/DPU 1928 can be coupled to network 1930 over Ethernet (ETH), NVLINK or InfiniBand (IB) connections, for example.

Computing system 1900 also includes a processing device 1904 with a multi-GPU architecture. In particular, processing device 1904 includes multiple subsystems including a CPU 1916, a GPU 1918, and a GPU 1920. CPU 1916 can be coupled to GPU 1918 via an D2D or C2C interconnect 1922. CPU 1916 can be coupled to GPU 1920 via a D2D or C2C interconnect 1924. CPU 1916 can also couple to GPU 1918 and GPU 1920 via PCIe interconnects. CPU 1916 can be coupled to one or more NICs or DPUs, which are coupled to one or more networks. For example, as illustrated in FIG. 19, CPU 1916 is coupled to a first NIC/DPU 1932, which is coupled to a network 1936. CPU 1916 is also coupled to a second NIC/DPU 1934, which is coupled to network 1936 via switch 1944. NIC/DPU 1932 and NIC/DPU 1934 can be coupled to network 1936 over Ethernet (ETH), NVLINK or InfiniBand (IB) connections.

In at least one example, processing device 1902 and processing device 1904 can communication with each other via a NIC/DPU 1938, such as over PCIe interconnects. Processing device 1902 and processing device 1904 can also communicate with each other over a high-bandwidth communication interconnects 1940, such as an NVLink interconnect or other high-speed interconnects. The packet switches in FIG. 19 may comprise, for example, Nvidia Quantum-2 switches. The NICs/DPUs in the figure may comprise, for example, Nvidia Bluefield DPUs.

### EXAMPLE STATEMENTS

In view of the above-described implementations of subject matter this application discloses the following list of examples, wherein one feature of an example in isolation or more than one feature of an example, taken in combination or in combination with one or more features of one or more further examples are further examples also falling within the disclosure of this application.

Example 1 includes a bi-directional optical communication module, comprising: a substrate; a first optical transmitter supported by the substrate and configured to generate a first optical signal having a first wavelength; a first optical receiver supported by the substrate and configured to receive a second optical signal having a second wavelength distinct from the first wavelength; and a tunable band pass filter supported by the substrate and communicably coupled to the first optical transmitter, the first optical receiver, and an optical port, the tunable band pass filter comprising a wavelength modification element configured to dynamically adjust a material refractive index of the tunable band pass filter in response to a control signal, wherein the dynamic adjustment configures the tunable band pass filter to: (a) pass the first optical signal from the first optical transmitter to the optical port; and (b) direct the second optical signal from the optical port into the first optical receiver.

Example 2 includes the bi-directional optical communication module of example 1, wherein the tunable band pass filter comprises an input port, a through port, a drop port, and an add port, wherein the first optical transmitter is communicably coupled with the input port, and the first optical receiver is communicably coupled with the add port.

Example 3 includes the bi-directional optical communication module of any preceding examples, wherein the wavelength modification element comprises a thermal heating element configured to locally modify a temperature of the tunable band pass filter so as to adjust the material refractive index.

Example 4 includes the bi-directional optical communication module of any preceding examples, wherein the wavelength modification element comprises a resistor or a diode.

Example 5 includes the bi-directional optical communication module of any preceding examples, wherein the control signal is configured to adjust the material refractive index to compensate for thermal drift in the first wavelength generated by the first optical transmitter.

Example 6 includes the bi-directional optical communication module of any preceding examples, wherein the dynamic adjustment of the material refractive index shifts a center wavelength of a pass-band of the tunable band pass filter.

Example 7 includes the bi-directional optical communication module of example 6, wherein the tunable band pass filter is configured to dynamically alter a spectral transfer function of the tunable band pass filter by shifting the center wavelength of the pass-band to maintain spectral alignment with the first wavelength and the second wavelength.

Example 8 includes the bi-directional optical communication module of any preceding examples, wherein the optical port comprises a v-groove edge coupler fabricated into the substrate.

Example 9 includes the bi-directional optical communication module of any preceding examples, wherein the optical port comprises a grating-based vertical coupler fabricated into the substrate.

Example 10 includes the bi-directional optical communication module of example 8, wherein the substrate is a silicon photonics substrate.

Example 11 includes the bi-directional optical communication module of any preceding examples, wherein the substrate comprises a photonic integrated circuit, and wherein the first optical transmitter, the first optical receiver, and the tunable band pass filter are monolithically integrated on the photonic integrated circuit.

Example 12 includes the bi-directional optical communication module of any preceding examples, further comprising a housing, wherein the substrate is co-packaged with an electrical-to-optical driver integrated circuit within the housing.

Example 13 includes the bi-directional optical communication module of example 12, wherein the electrical-to-optical driver integrated circuit is configured to generate the control signal provided to the wavelength modification element.

Example 14 includes the bi-directional optical communication module of any preceding examples, wherein the first optical transmitter comprises a vertical-cavity surface-emitting laser configured to generate optical signals having the first wavelength.

Example 15 includes the bi-directional optical communication module of any preceding examples, wherein the first optical transmitter comprises a multi-wavelength laser source configured to generate the first optical signal having the first wavelength, the first wavelength comprising a set of wavelengths within a first spectral band.

Example 16 includes the bi-directional optical communication module of example 15, wherein the multi-wavelength laser source comprises a mode-locked comb laser configured to generate a plurality of discrete wavelength lines within the first spectral band.

Example 17 includes the bi-directional optical communication module of any of examples 15-16, wherein the multi-wavelength laser source comprises a bank of lasers, each laser of the bank configured to generate a respective wavelength line within the first spectral band.

Example 18 includes the bi-directional optical communication module of any preceding examples, wherein the first optical receiver comprises a photodiode configured to receive optical signals having the second wavelength.

Example 19 includes the bi-directional optical communication module of any preceding examples, wherein the first optical transmitter comprises a second band pass filter configured to selectively generate optical signals having the first wavelength, the second band pass filter comprising a second wavelength modification element configured to selectively modify a material refractive index of the second band pass filter to output the first optical signal having the first wavelength.

Example 20 includes the bi-directional optical communication module of any preceding examples, further comprising an optical fiber communicably coupled with the optical port, wherein the optical fiber is configured to simultaneously carry the first optical signal having the first wavelength and the second optical signal having the second wavelength.

Example 21 includes a computing system, comprising: a main circuit board; a hardware accelerator mounted on the main circuit board; and a bi-directional optical communication module mounted on the main circuit board and communicatively coupled to the hardware accelerator, the module configured to establish a bi-directional optical link to a remote system over an optical fiber, the module comprising: a transmitter configured to transmit first data received from the hardware accelerator as a first optical signal having a first wavelength; a receiver configured to receive a second optical signal having a second wavelength distinct from the first wavelength and to provide second data derived from the second optical signal to the hardware accelerator; and a band pass filter configured to: (a) pass the first optical signal from the transmitter to the optical fiber; and (b) direct the second optical signal from the optical fiber into the receiver.

Example 22 includes the computing system of example 21, wherein the first optical signal and the second optical signal are transmitted simultaneously over the optical fiber.

Example 23 includes the computing system of any of examples 21-22, wherein the module further comprises a substrate, wherein the transmitter, the receiver, and the band pass filter are supported by the substrate.

Example 24 includes the computing system of any of examples 21-23, wherein the bi-directional optical communication module is configured to operate according to an NVLink communication protocol.

Example 25 includes the computing system of example 24, wherein the hardware accelerator and the bi-directional optical communication module are communicatively coupled via an NVLink electrical interface, and wherein the module converts NVLink electrical signals to optical signals for transmission over the optical fiber and converts received optical signals to NVLink electrical signals for delivery to the hardware accelerator.

Example 26 includes the computing system of any of examples 21-25, wherein the remote system comprises a second hardware accelerator communicatively coupled with a second bi-directional optical communication module, the second bi-directional optical communication module comprising: a second transmitter configured to generate optical signals having the second wavelength; a second receiver configured to receive optical signals having the first wavelength; and a second band pass filter communicably coupled to the second transmitter, the second receiver, and the optical fiber, the optical fiber communicably coupling the band pass filter and the second band pass filter.

Example 27 includes the computing system of example 26, wherein the hardware accelerator and the second hardware accelerator exchange data simultaneously over the optical fiber, the first optical signal carrying data from the hardware accelerator to the second hardware accelerator and the second optical signal carrying data from the second hardware accelerator to the hardware accelerator.

Example 28 includes the computing system of any of examples 21-27, wherein the bi-directional optical communication module is pluggably received in a module receptacle on the main circuit board.

Example 29 includes the computing system of example 28, wherein the bi-directional optical communication module conforms to an OSFP, QSFP-DD, or QSFP form factor.

Example 30 includes the computing system of any of examples 21-29, wherein the bi-directional optical communication module further comprises a driver integrated circuit configured to receive the first data from the hardware accelerator and to drive the transmitter to generate the first optical signal.

Example 31 includes the computing system of example 30, wherein the bi-directional optical communication module further comprises a transimpedance amplifier configured to convert the second optical signal received by the receiver into the second data for delivery to the hardware accelerator.

Example 32 includes the computing system of any of examples 21-31, wherein the band pass filter comprises a wavelength modification element configured to dynamically adjust a material refractive index of the band pass filter to selectively pass optical signals at the first wavelength and selectively direct optical signals at the second wavelength.

Example 33 includes the computing system of any of examples 21-32, wherein the transmitter comprises a vertical-cavity surface-emitting laser and the receiver comprises a photodiode.

Example 34 includes the computing system of any of examples 21-33, wherein the main circuit board is disposed within a server chassis, and the optical fiber extends from the bi-directional optical communication module to a second bi-directional optical communication module disposed within a second server chassis.

Example 35 includes the computing system of any of examples 21-34, wherein the bi-directional optical communication module reduces a fiber count by at least a factor of two compared to a unidirectional optical link carrying equivalent aggregate data between the hardware accelerator and the remote system.

Example 36 includes the bi-directional optical interconnect module for simultaneous transmission and reception over an optical fiber, the module comprising: a transmitter configured to generate a transmitted optical signal having a first wavelength; a receiver configured to receive a received optical signal having a second wavelength distinct from the first wavelength; and a band pass filter communicably coupled to the transmitter, the receiver, and the optical fiber, the band pass filter configured to pass the transmitted optical signal into the optical fiber and to direct the received optical signal from the optical fiber into the receiver, the module configured to achieve a combined, simultaneous bi-directional data throughput of at least 800 Gigabits per second, and the band pass filter providing a spectral crosstalk isolation of greater than 25 dB between the transmitted optical signal and the received optical signal.

Example 37 includes the bi-directional optical interconnect module of example 36, wherein the band pass filter exhibits an insertion loss of less than 2.5 dB for the transmitted optical signal passing from the transmitter through the band pass filter into the optical fiber.

Example 38 includes the bi-directional optical interconnect module of any of examples 36-37, wherein the band pass filter exhibits an insertion loss of less than 2.5 dB for the received optical signal passing from the optical fiber through the band pass filter into the receiver.

Example 39 includes the bi-directional optical interconnect module of any of examples 36-38, wherein the module has a power consumption of less than 5 watts while operating at the combined, simultaneous bi-directional data throughput of at least 800 Gigabits per second.

Example 40 includes the bi-directional optical interconnect module of any of examples 36-39, wherein the module is configured to maintain a bit error rate below 10⁻¹² across an operating temperature range of 0 to 70 degrees Celsius.

Example 41 includes the bi-directional optical interconnect module of any of examples 36-40, wherein the transmitter comprises a vertical-cavity surface-emitting laser and the receiver comprises a photodiode.

Example 42 includes the bi-directional optical interconnect module of any of examples 36-41, wherein the band pass filter comprises a wavelength modification element configured to dynamically adjust a material refractive index of the band pass filter.

Many modifications and other examples of the present disclosure will come to mind to one skilled in the art to which these examples pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the examples are not to be limited to the specific examples disclosed and that modifications and other examples are intended to be included within the scope of the appended claims. Although specific terms are employed herein, they are used in a generic and descriptive sense only and not for purposes of limitation.

1. A bi-directional optical communication module, comprising:
a substrate;
a first optical transmitter supported by the substrate and configured to generate a first optical signal having a first wavelength;
a first optical receiver supported by the substrate and configured to receive a second optical signal having a second wavelength distinct from the first wavelength; and
a tunable band pass filter supported by the substrate and communicably coupled to the first optical transmitter, the first optical receiver, and an optical port, the tunable band pass filter comprising a wavelength modification element configured to dynamically adjust a material refractive index of the tunable band pass filter in response to a control signal, wherein the dynamic adjustment configures the tunable band pass filter to:
(a) pass the first optical signal from the first optical transmitter to the optical port; and
(b) direct the second optical signal from the optical port into the first optical receiver.

2. The bi-directional optical communication module of claim 1, wherein the tunable band pass filter comprises an input port, a through port, a drop port, and an add port, wherein the first optical transmitter is communicably coupled with the input port, and the first optical receiver is communicably coupled with the add port.

3. The bi-directional optical communication module of claim 1, wherein the wavelength modification element comprises a thermal heating element configured to locally modify a temperature of the tunable band pass filter so as to adjust the material refractive index.

4. The bi-directional optical communication module of claim 1, wherein the wavelength modification element comprises a resistor or a diode.

5. The bi-directional optical communication module of claim 1, wherein the control signal is configured to adjust the material refractive index to compensate for thermal drift in the first wavelength generated by the first optical transmitter.

6. The bi-directional optical communication module of claim 1, wherein the dynamic adjustment of the material refractive index shifts a center wavelength of a pass-band of the tunable band pass filter.

7. The bi-directional optical communication module of claim 6, wherein the tunable band pass filter is configured to dynamically alter a spectral transfer function of the tunable band pass filter by shifting the center wavelength of the pass-band to maintain spectral alignment with the first wavelength and the second wavelength.

8. The bi-directional optical communication module of claim 1, wherein the optical port comprises a v-groove edge coupler fabricated into the substrate.

9. The bi-directional optical communication module of claim 1, wherein the optical port comprises a grating-based vertical coupler fabricated into the substrate.

10. The bi-directional optical communication module of claim 1, wherein the substrate comprises a photonic integrated circuit, and wherein the first optical transmitter, the first optical receiver, and the tunable band pass filter are monolithically integrated on the photonic integrated circuit.

11. The bi-directional optical communication module of claim 1, further comprising a housing, wherein the substrate is co-packaged with an electrical-to-optical driver integrated circuit within the housing.

12. The bi-directional optical communication module of claim 11, wherein the electrical-to-optical driver integrated circuit is configured to generate the control signal provided to the wavelength modification element.

13. The bi-directional optical communication module of claim 1, wherein the first optical transmitter comprises a vertical-cavity surface-emitting laser configured to generate optical signals having the first wavelength.

14. The bi-directional optical communication module of claim 1, wherein the first optical transmitter comprises a multi-wavelength laser source configured to generate the first optical signal having the first wavelength, the first wavelength comprising a set of wavelengths within a first spectral band.

15. The bi-directional optical communication module of claim 1, wherein the first optical receiver comprises a photodiode configured to receive optical signals having the second wavelength.

16. The bi-directional optical communication module of claim 1, wherein the first optical transmitter comprises a second band pass filter configured to selectively generate optical signals having the first wavelength, the second band pass filter comprising a second wavelength modification element configured to selectively modify a material refractive index of the second band pass filter to output the first optical signal having the first wavelength.

17. The bi-directional optical communication module of claim 1, further comprising an optical fiber communicably coupled with the optical port, wherein the optical fiber is configured to simultaneously carry the first optical signal having the first wavelength and the second optical signal having the second wavelength.

18. A computing system, comprising:
a main circuit board;
a hardware accelerator mounted on the main circuit board; and
a bi-directional optical communication module mounted on the main circuit board and communicatively coupled to the hardware accelerator, the module configured to establish a bi-directional optical link to a remote system over an optical fiber, the module comprising:
a transmitter configured to transmit first data received from the hardware accelerator as a first optical signal having a first wavelength;
a receiver configured to receive a second optical signal having a second wavelength distinct from the first wavelength and to provide second data derived from the second optical signal to the hardware accelerator; and
a band pass filter configured to: (a) pass the first optical signal from the transmitter to the optical fiber; and (b) direct the second optical signal from the optical fiber into the receiver.

19. The computing system of claim 18, wherein the remote system comprises a second hardware accelerator communicatively coupled with a second bi-directional optical communication module, the second bi-directional optical communication module comprising:
a second transmitter configured to generate optical signals having the second wavelength;
a second receiver configured to receive optical signals having the first wavelength; and
a second band pass filter communicably coupled to the second transmitter, the second receiver, and the optical fiber,

20. The computing system of claim 18, wherein the bi-directional optical communication module is pluggably received in a module receptacle on the main circuit board.
